(19) United States
(12) Patent Application Publication
(10) Pub. No.: US 2024/0155639 A1
(43) Pub. Date: May 9, 2024

(54) METHOD AND DEVICE IN NODES USED FOR WIRELESS COMMUNICATION

(71) Applicants: Zheng LIU, Shanghai (CN); Xiaobo ZHANG, Shanghai (CN)

(72) Inventors: Zheng LIU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/386,604

(22) Filed: Nov. 3, 2023

(30) Foreign Application Priority Data
Nov. 3, 2022 (CN) 202211374336.5

(51) Int. Cl. H04W 72/232; H04W 72/0446; H04W 72/12

(52) U.S. Cl. CPC H04W 72/232; H04W 72/0446; H04W 72/12

(57) ABSTRACT

The present application discloses a method and a device in a node for wireless communications. A node receives a first information block, the first information block used for determining a reference cell, the reference cell belonging to a first cell set; and the node monitors in a first time window at least one PDCCH candidate for DCI format(s) in a target DCI format set; a PDCCH candidate monitored for a DCI format in the target DCI format set is counted for PDCCH candidates monitored for the reference cell; a number of PDCCH candidates monitored for the reference cell in the first time window is no greater than a first threshold, and a number of non-overlapped CCEs for the reference cell in the first time window is no greater than a second threshold. The present application ensures the flexibility.

### CROSS REFERENCE TO RELATED APPLICATIONS

This application claims the priority benefit of Chinese Patent Application No. 202211374336.5, filed on Nov. 3, 2022, the full disclosure of which is incorporated herein by reference.

### BACKGROUND

### Technical Field

The present application relates to transmission methods and devices in wireless communication systems, and in particular to a multi-carrier transmission scheme and device in wireless communications.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 session to standardize the NR.

The multi-carrier (including Carrier Aggregation, abbreviated as CA, and Dual Connectivity, abbreviated as DC) techniques is an integral part of New Radio (NR) technology. To adapt to diverse application scenarios and meet different requests, the 3GPP has been working on the evolution of multi-carrier techniques since from the Rel-15.

### SUMMARY

In the multi-carrier communications, for instance Carrier Aggregation (CA), Cross Carrier Scheduling is supported. In networks supported by the existing standard, such as 5G New Radio (NR) in R17 and of previous versions, for multiple scheduled carriers, scheduling is only supported to be provided on carriers or Physical Downlink Control Channels (PDCCHs) respectively corresponding to the carriers, rather than through a same PDCCH on a same carrier.

To address the issue of scheduling PDSCHs or PUSCHs on multiple carriers simultaneously with a same PDCCH in an NR multicarrier system, the present application provides a solution. It should be noted that the statement in the present application only takes PDCCH scheduling in the multicarrier case as a typical application scenario or example; this disclosure is also applicable to other scenarios confronting similar problems, such as other scenarios having higher demands on the capacity of control channels, which include but are not limited to capacity enhancement system, the system using higher frequency, coverage enhancement system, Unlicensed Spectrum communication, the Internet of Things (IoT), Ultra Reliable Low Latency Communications (URLLC) network and Vehicle-to-Everything (V2X), where similar technical effects can be achieved. Additionally, the adoption of a unified solution for various scenarios, including but not limited to multi-carrier scenarios, contributes to the reduction of hardcore complexity and costs. In the case of no conflict, the embodiments of a first node and the characteristics in the embodiments may be applied to a second node, and vice versa. Particularly, for interpretations of the terminology, nouns, functions and variables (unless otherwise specified) in the present application, refer to definitions given in TS36 series, TS38 series and TS37 series of 3GPP specifications.

The present application provides a method in a first node for wireless communications, comprising:
receiving a first information block, the first information block used for determining a reference cell, the reference cell belonging to a first cell set, the first cell set comprising multiple cells; and
monitoring in a first time window at least one PDCCH candidate for DCI format(s) in a target DCI format set, the target DCI format set comprising at least one DCI format for the first cell set;
herein, a PDCCH candidate monitored for a DCI format in the target DCI format set is counted for PDCCH candidates monitored for the reference cell; a number of PDCCH candidates monitored for the reference cell in the first time window is no greater than a first threshold, and a number of non-overlapped CCEs for the reference cell in the first time window is no greater than a second threshold, where the first threshold is a positive integer, and the second threshold is a positive integer; a first subcarrier spacing is equal to a subcarrier spacing of at least one subcarrier occupied by the at least one PDCCH candidate monitored in the first time window for DCI format(s) in the target DCI format set in frequency domain, where the first threshold is related to the first subcarrier spacing, and the second threshold is related to the first subcarrier spacing, the first subcarrier spacing being used to determine a time length of one multicarrier symbol comprised by the first time window.

According to one aspect of the present application, the above method is characterized in that a target candidate set comprises PDCCH candidate(s) monitored for the reference cell, and a first PDCCH candidate belongs to a search space configured for the reference cell, whether the first PDCCH candidate belongs to the target candidate set is related to whether the search space to which the first PDCCH candidate belongs is configured with at least one DCI format in the target DCI format set.

According to one aspect of the present application, the above method is characterized in that the first information block is used for determining a first identity value, the first identity value being a non-negative number; each cell in the first cell set corresponds to one identity value, and the reference cell is a cell in the first cell set corresponding to an identity value equal to the first identity value; a Carrier Indicator Field (CIF) value corresponding to the reference cell is used to determine a CCE occupied by the at least one PDCCH candidate monitored using DCI format(s) in the target DCI format set.

According to one aspect of the present application, the above method is characterized in that the first cell set comprises H cell subsets, and any cell subset among the H cell subsets comprises at least one cell, and each cell comprised by any cell subset among the H cell subsets belongs to the first cell set, H being a positive integer greater than 1; size(s) of at least one DCI format in the target DCI format set is(are) related to a number of cells comprised by one cell subset with most cells among the H cell subsets.

According to one aspect of the present application, the above method is characterized in that the reference cell is a cell in the first cell set configured with a search space that uses one or more DCI formats only in a reference DCI format set and comprises a smallest total number of PDCCH candidates, where the reference DCI format set is pre-defined or configurable.

According to one aspect of the present application, the above method is characterized in that a first scheduling cell is a scheduling cell for the first cell set, and the first scheduling cell is configured with a first search space, a reference identity value being equal to an identity value of the first search space; a characteristic quantity value is equal to a number of PDCCH candidate(s) using a first Aggregation Level (AL) for the first cell set comprised by the first search space, where the first AL is a positive integer; a number of PDCCH candidate(s) using the first AL configured for a search space for any cell in the first cell set and with an identity value equal to the reference identity value is used to determine the characteristic quantity value.

According to one aspect of the present application, the above method is characterized in comprising:
transmitting a second information block;
herein, the second information block is used to indicate a capability parameter set of a transmitter of the second information block, the capability parameter set of the transmitter of the second information block at least comprising a first parameter and a second parameter; the first parameter is used to indicate a number of downlink serving cells simultaneously scheduled by a PDCCH that are supported by the transmitter of the second information block, while the second parameter is used to indicate a number of uplink serving cells simultaneously scheduled by a PDCCH that are supported by the transmitter of the second information block.

The present application provides a method in a second node for wireless communications, comprising:
transmitting a first information block, the first information block used for determining a reference cell, the reference cell belonging to a first cell set, the first cell set comprising multiple cells; and
determining in a first time window at least one PDCCH candidate for DCI format(s) in a target DCI format set, the target DCI format set comprising at least one DCI format for the first cell set;
herein, a PDCCH candidate monitored for a DCI format in the target DCI format set is counted for PDCCH candidates monitored for the reference cell; a number of PDCCH candidates monitored for the reference cell in the first time window is no greater than a first threshold, and a number of non-overlapped CCEs for the reference cell in the first time window is no greater than a second threshold, where the first threshold is a positive integer, and the second threshold is a positive integer; a first subcarrier spacing is equal to a subcarrier spacing of at least one subcarrier occupied by the at least one PDCCH candidate monitored in the first time window for DCI format(s) in the target DCI format set in frequency domain, where the first threshold is related to the first subcarrier spacing, and the second threshold is related to the first subcarrier spacing, the first subcarrier spacing being used to determine a time length of one multicarrier symbol comprised by the first time window.

According to one aspect of the present application, the above method is characterized in that a target candidate set comprises PDCCH candidate(s) monitored for the reference cell, and a first PDCCH candidate belongs to a search space configured for the reference cell, whether the first PDCCH candidate belongs to the target candidate set is related to whether the search space to which the first PDCCH candidate belongs is configured with at least one DCI format in the target DCI format set.

According to one aspect of the present application, the above method is characterized in that the first information block is used for determining a first identity value, the first identity value being a non-negative number; each cell in the first cell set corresponds to one identity value, and the reference cell is a cell in the first cell set corresponding to an identity value equal to the first identity value; a Carrier Indicator Field (CIF) value corresponding to the reference cell is used to determine a CCE occupied by the at least one PDCCH candidate monitored using DCI format(s) in the target DCI format set.

According to one aspect of the present application, the above method is characterized in that the first cell set comprises H cell subsets, and any cell subset among the H cell subsets comprises at least one cell, and each cell comprised by any cell subset among the H cell subsets belongs to the first cell set, H being a positive integer greater than 1; size(s) of at least one DCI format in the target DCI format set is(are) related to a number of cells comprised by one cell subset with most cells among the H cell subsets.

According to one aspect of the present application, the above method is characterized in that the reference cell is a cell in the first cell set configured with a search space that uses one or more DCI formats only in a reference DCI format set and comprises a smallest total number of PDCCH candidates, where the reference DCI format set is pre-defined or configurable.

According to one aspect of the present application, the above method is characterized in that a first scheduling cell is a scheduling cell for the first cell set, and the first scheduling cell is configured with a first search space, a reference identity value being equal to an identity value of the first search space; a characteristic quantity value is equal to a number of PDCCH candidate(s) using a first Aggregation Level (AL) for the first cell set comprised by the first search space, where the first AL is a positive integer; a number of PDCCH candidate(s) using the first AL configured for a search space for any cell in the first cell set and with an identity value equal to the reference identity value is used to determine the characteristic quantity value.

According to one aspect of the present application, the above method is characterized in comprising:
receiving a second information block;
herein, the second information block is used to indicate a capability parameter set of a transmitter of the second information block, the capability parameter set of the transmitter of the second information block at least comprising a first parameter and a second parameter; the first parameter is used to indicate a number of downlink serving cells simultaneously scheduled by a PDCCH that are supported by the transmitter of the second information block, while the second parameter is used to indicate a number of uplink serving cells simultaneously scheduled by a PDCCH that are supported by the transmitter of the second information block.

The present application provides a first node for wireless communications, comprising:
a first transceiver, receiving a first information block, the first information block used for determining a reference cell, the reference cell belonging to a first cell set, the first cell set comprising multiple cells; and
a first receiver, monitoring in a first time window at least one PDCCH candidate for DCI format(s) in a target DCI format set, the target DCI format set comprising at least one DCI format for the first cell set;
herein, a PDCCH candidate monitored for a DCI format in the target DCI format set is counted for PDCCH candidates monitored for the reference cell; a number of PDCCH candidates monitored for the reference cell in the first time window is no greater than a first threshold, and a number of non-overlapped CCEs for the reference cell in the first time window is no greater than a second threshold, where the first threshold is a positive integer, and the second threshold is a positive integer; a first subcarrier spacing is equal to a subcarrier spacing of at least one subcarrier occupied by the at least one PDCCH candidate monitored in the first time window for DCI format(s) in the target DCI format set in frequency domain, where the first threshold is related to the first subcarrier spacing, and the second threshold is related to the first subcarrier spacing, the first subcarrier spacing being used to determine a time length of one multicarrier symbol comprised by the first time window.

The present application provides a second node for wireless communications, comprising:
a second transceiver, transmitting a first information block, the first information block used for determining a reference cell, the reference cell belonging to a first cell set, the first cell set comprising multiple cells; and
a first transmitter, determining in a first time window at least one PDCCH candidate for DCI format(s) in a target DCI format set, the target DCI format set comprising at least one DCI format for the first cell set;
herein, a PDCCH candidate monitored for a DCI format in the target DCI format set is counted for PDCCH candidates monitored for the reference cell; a number of PDCCH candidates monitored for the reference cell in the first time window is no greater than a first threshold, and a number of non-overlapped CCEs for the reference cell in the first time window is no greater than a second threshold, where the first threshold is a positive integer, and the second threshold is a positive integer; a first subcarrier spacing is equal to a subcarrier spacing of at least one subcarrier occupied by the at least one PDCCH candidate monitored in the first time window for DCI format(s) in the target DCI format set in frequency domain, where the first threshold is related to the first subcarrier spacing, and the second threshold is related to the first subcarrier spacing, the first subcarrier spacing being used to determine a time length of one multicarrier symbol comprised by the first time window.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first information block and monitoring PDCCH candidates according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first node and a second node according to one embodiment of the present application.

FIG. 5 illustrates a flowchart of radio signal transmission according to one embodiment of the present application.

FIG. 6 illustrates a schematic diagram of a target candidate set according to one embodiment of the present application.

FIG. 7 illustrates a schematic diagram of a CIF value corresponding to a reference cell according to an embodiment of the present application.

FIG. 8 illustrates a schematic diagram of a first cell set according to one embodiment of the present application.

FIG. 9 illustrates a schematic diagram of a reference cell according to an embodiment of the present application.

FIG. 10 illustrates a schematic diagram of a first scheduling cell according to one embodiment of the present application.

FIG. 11 illustrates a schematic diagram of a first parameter and a second parameter according to one embodiment of the present application.

FIG. 12 illustrates a structure block diagram of a processing device in a first node according to one embodiment of the present application.

FIG. 13 illustrates a structure block diagram a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

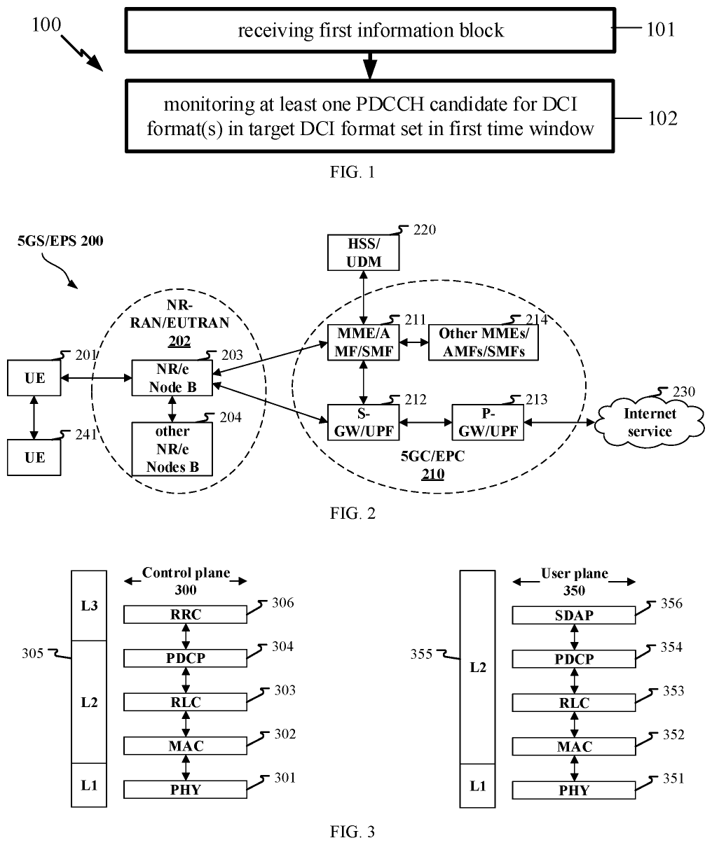

Embodiment 1 illustrates a flowchart 100 of a first information block and monitoring PDCCH candidates according to one embodiment of the present application, as shown in FIG. 1. In FIG. 1, each step represents a step, it should be particularly noted that the sequence order of each box herein does not restrict a chronological order of steps marked respectively by these boxes.

In Embodiment 1, the first node in the present application receives a first information block in step 101, the first information block used for determining a reference cell, the reference cell belonging to a first cell set, the first cell set comprising multiple cells; the first node in the present application monitors in a first time window at least one PDCCH candidate for DCI format(s) in a target DCI format set in step 102, the target DCI format set comprising at least one DCI format for the first cell set; herein, a PDCCH candidate monitored for a DCI format in the target DCI format set is counted for PDCCH candidates monitored for the reference cell; a number of PDCCH candidates monitored for the reference cell in the first time window is no greater than a first threshold, and a number of non-overlapped CCEs for the reference cell in the first time window is no greater than a second threshold, where the first threshold is a positive integer, and the second threshold is a positive integer; a first subcarrier spacing is equal to a subcarrier spacing of at least one subcarrier occupied by the at least one PDCCH candidate monitored in the first time window for DCI format(s) in the target DCI format set in frequency domain, where the first threshold is related to the first subcarrier spacing, and the second threshold is related to the first subcarrier spacing, the first subcarrier spacing being used to determine a time length of one multicarrier symbol comprised by the first time window.

In one embodiment, configuring a reference cell explicitly or implicitly through a first information block avoids the situation in which the flexibility of scheduling of fixed serving cells is restricted as a result of imbalance between PDCCH candidates and non-overlapped CCEs when scheduling multiple cells with a single PDCCH or DCI format.

In one embodiment, maintaining a first threshold and a second threshold avoids the situation in which the complexity of blind detection and channel estimation of PDCCH candidates of the UE is increased due to simultaneous scheduling of multiple cells with a single PDCCH or DCI format.

In one embodiment, the first information block is transmitted via an air interface or a wireless interface.

In one embodiment, the first information block comprises all or part of a higher layer signaling or a physical layer signaling.

In one embodiment, the first information block comprises all or part of a Radio Resource Control (RRC) layer signaling, or the first information block comprises all or part of a Medium Access Control (MAC) layer signaling.

In one embodiment, the first information block comprises all or part of a System Information Block (SIB).

In one embodiment, the first information block is UE-specific.

In one embodiment, the first information block is configured per carrier, or the first information block is configured per bandwidth part (BWP), or the first information block is configured per search space.

In one embodiment, the first information block is configured per band or configured per Frequency Range (FR).

In one embodiment, the first information block comprises all or partial fields in an Information Element (IE) “CellGroupConfig”.

In one embodiment, the first information block comprises a Field “secondaryCellGroup”, or the first information block comprises a Field “masterCellGroup”.

In one embodiment, the first information block is configured Per Cell group, or the first information block is configured Per PUCCH (PUCCH as the abbreviation for Physical Uplink Control Channel) group.

In one embodiment, the first information block comprises all or partial fields in an IE “ServingCellConfig”, or the first information block comprises all or partial fields in an IE “BWP-Downlink”, or the first information block comprises all or partial fields in an IE “crossCarrierSchedulingConfig”, or the first information block comprises all or partial fields in an IE “PDCCH-ServingCellConfig”.

In one embodiment, the first information block comprises all or partial fields in an IE “pdcch-ConfigCommon”.

In one embodiment, the first information block comprises all or partial fields in an IE “BWP-DownlinkCommon”.

In one embodiment, the first information block comprises all or partial fields in an IE “BWP-DownlinkDedicated”.

In one embodiment, the first information block comprises all or partial fields in an IE “pdcch-Config”.

In one embodiment, the first information block comprises all or partial fields in an IE “SearchSpace”.

In one embodiment, the first information block comprises all or partial fields in an IE “SearchSpaceExt-v1800”, or the first information block comprises all or partial fields in an IE “SearchSpaceExt2-r18”.

In one embodiment, the first information block comprises all or partial fields in a Downlink Control Information (DCI) format.

In one embodiment, the first information block is configured for scheduling cell(s) of at least one cell in the first cell set.

In one embodiment, the first information block is comprised in a configuration signaling for configuring BWP(s) or PDCCH(s) on scheduling cell(s) of at least one cell in the first cell set.

In one embodiment, the first information block is comprised in a configuration signaling for configuring a cell group to which at least one cell in the first cell set belongs.

In one embodiment, the technical feature of “the first information block used for determining a reference cell” includes the following meaning: the first information block is used by the first node in the present application to determine the reference cell.

In one embodiment, the technical feature of “the first information block used for determining a reference cell” includes the following meaning: all or part of the first information block is used for explicitly or implicitly indicating the reference cell.

In one embodiment, the technical feature of “the first information block used for determining a reference cell” includes the following meaning: all or part of the first information block is used for explicitly or implicitly indicating the reference cell in the first cell set.

In one embodiment, the technical feature of “the first information block used for determining a reference cell” includes the following meaning: the first information block is used to determine the first cell set.

In one embodiment, the technical feature of “the first information block used for determining a reference cell” includes the following meaning: the first information block is used to determine an indication value; an information block other than the first information block is used to determine indication value(s) corresponding to at least one cell comprised by the first cell set, where the reference cell is a cell in the first cell set to which an indication value corresponds is equal to the indication value determined by the first information block.

In one embodiment, the technical feature of “the first information block used for determining a reference cell” includes the following meaning: the first information block is used to determine the first cell set, where the reference cell is a pre-defined cell in the first cell set. In one subsidiary embodiment of the above embodiment, the reference cell is a cell with a largest identity value or index value in the first cell set. In one subsidiary embodiment of the above embodiment, the reference cell is a cell with a smallest identity value or index value in the first cell set. In one subsidiary embodiment of the above embodiment, the reference cell is a cell with a largest or a smallest carrier indicator field (CIF) value in the first cell set. In one subsidiary embodiment of the above embodiment, the reference cell is a cell in the first cell set configured with a largest or smallest number of PDCCH candidates in total.

In one embodiment, the technical feature of “the first information block used for determining a reference cell” includes the following meaning: all or part of the first information block is used for explicitly or implicitly indicating an identity value or an index value of the reference cell.

In one embodiment, the reference cell is a cell other than a primary cell (Pcell).

In one embodiment, the reference cell is a cell other than a special cell (SpCell).

In one embodiment, the reference cell can only be a secondary cell (Scell).

In one embodiment, the first node expects (or assumes) that the reference cell is an Scell.

In one embodiment, the reference cell is a primary cell (Pcell).

In one embodiment, the reference cell is a special cell (SpCell).

In one embodiment, the reference cell is a cell with a largest identity value or index value in the first cell set.

In one embodiment, the reference cell is a cell with a smallest identity value or index value in the first cell set.

In one embodiment, the reference cell is a cell with a largest or a smallest carrier indicator field (CIF) value in the first cell set.

In one embodiment, statements like “search space” and “search space set” can have equivalent meaning or are mutually replaceable.

In one embodiment, all or part of the first information block is used for explicitly or implicitly indicating the first cell set.

In one embodiment, a signaling other than the first information block is used for explicitly or implicitly indicating the first cell set.

In one embodiment, a number of cells comprised by the first cell set is no greater than 8.

In one embodiment, a number of cells comprised by the first cell set is no greater than 4.

In one embodiment, a number of cells comprised by the first cell set is no greater than 16.

In one embodiment, a bitmap indicated by a signaling is used for explicitly or implicitly indicating the first cell set.

In one embodiment, the first cell set is obtained by a signaling adding cell(s) in the first cell set, or the first cell set is obtained by a signaling releasing cell(s) from the first cell set.

In one embodiment, a signaling comprises add list sub-information-blocks and release list sub-information-blocks, where the add list sub-information-blocks are used for adding cells in the first cell set, while the release list sub-information-blocks are used for releasing cells from the first cell set.

In one embodiment, a signaling is used to determine W3 cell sets, any cell set of the W3 cell sets comprising at least one cell, where W3 is a positive integer greater than 1; the first cell set comprises any cell in the W3 cell sets.

In one embodiment, a signaling is used to determine W1 cell sets and W2 cell sets, any cell set of the W1 cell sets comprising at least one cell, and any cell set of the W2 cell sets comprising at least one cell, where W1 is a positive integer greater than 1, and W2 is a positive integer greater than 1; the first cell set comprises each cell comprised by any cell set among the W1 cell sets, and the first cell set comprises each cell comprised by any cell set among the W2 cell sets.

In one embodiment, statements like “cell” and “serving cell” can have equivalent meaning or are mutually replaceable.

In one embodiment, any cell comprised by the first cell set is a serving cell.

In one embodiment, any cell comprised by the first cell set is a component carrier (CC) for carrier aggregation (CA).

In one embodiment, any cell comprised by the first cell set is a carrier.

In one embodiment, any two cells comprised by the first cell set belong to a same band.

In one embodiment, the first cell set comprises two cells respectively belonging to different bands.

In one embodiment, the first cell set only comprises intra-band cells.

In one embodiment, the first cell set only comprises inter-band cells.

In one embodiment, any cell comprised by the first cell set belongs to a Master Cell Group (MCG).

In one embodiment, any cell comprised by the first cell set belongs to a Secondary Cell Group (SCG).

In one embodiment, any two cells comprised by the first cell set belong to a same cell group.

In one embodiment, any two cells comprised by the first cell set belong to a same PUCCH group.

In one embodiment, the first cell set comprises both cells in a Master Cell Group (MCG) and cells in a Secondary Cell Group (SCG).

In one embodiment, the first cell set comprises a Special Cell (SpCell).

In one embodiment, the first cell set comprises no Special Cell (SpCell).

In one embodiment, any two cells comprised by the first cell set share a same scheduling cell.

In one embodiment, the first cell set comprises two cells of which scheduling cells are different.

In one embodiment, any cell comprised by the first cell set is an Activated Cell.

In one embodiment, the first cell set comprises a cell which is a Deactivated Cell.

In one embodiment, a number of cells comprised by the first cell set is no greater than a maximum number of simultaneously scheduled cells indicated by a capability report of the first node.

In one embodiment, a number of cells comprised by the first cell set is greater than a maximum number of simultaneously scheduled cells indicated by a capability report of the first node.

In one embodiment, active BWPs that respectively belong to any two cells comprised by the first cell set have equivalent subcarrier spacings.

In one embodiment, the first cell set consists of cells that can be scheduled simultaneously by a PDCCH or a DCI format.

In one embodiment, two or more cells comprised by the first cell set can be configured to be scheduled simultaneously by a PDCCH or a DCI format.

In one embodiment, any one cell set that can be configured to be scheduled simultaneously by a PDCCH or a DCI format belongs to the first cell set.

In one embodiment, the first time window is a slot.

In one embodiment, the first time window consists of multiple time-domain consecutive slots.

In one embodiment, the first time window is a span.

In one embodiment, the first time window is time-domain resources occupied by an Aligned Span.

In one embodiment, any multicarrier symbol comprised by the first time window is an Orthogonal Frequency Division Multiplexing (OFDM) Symbol.

In one embodiment, any multicarrier symbol comprised by the first time window is a time-domain symbol.

In one embodiment, the first time window comprises multiple time-domain consecutive multicarrier symbols.

In one embodiment, the first time window is a shortest time interval of all time intervals between earliest OFDM symbols in two PDCCH Occasions.

In one embodiment, a number of multicarrier symbols comprised by the first time window is equal to one of positive integers comprised by a Combination.

In one embodiment, time-domain resources occupied by any PDCCH candidate monitored in the first time window belong to the first time window.

In one embodiment, monitoring of any PDCCH candidate in the first time window is implemented through Decoding of the PDCCH candidate.

In one embodiment, monitoring of any PDCCH candidate in the first time window is implemented through Blind Decoding of the PDCCH candidate.

In one embodiment, monitoring of any PDCCH candidate in the first time window is implemented through decoding and CRC check of the PDCCH candidate.

In one embodiment, monitoring of any PDCCH candidate in the first time window is implemented through decoding and CRC of the PDCCH candidate, with CRC being scrambled by a Radio Network Temporary Identity (RNTI).

In one embodiment, monitoring of any PDCCH candidate in the first time window is implemented based on Decoding of the PDCCH candidate by one or more DCI Formats being monitored.

In one embodiment, any PDCCH candidate monitored in the first time window occupies a positive integer number of Control Channel Element(s) (CCE(s)).

In one embodiment, any PDCCH candidate monitored in the first time window occupies 1 CCE or 2 CCEs or 4 CCEs or 8 or 16 CCEs.

In one embodiment, any PDCCH candidate monitored in the first time window is a PDCCH candidate that uses one or more DCI formats.

In one embodiment, any PDCCH candidate monitored in the first time window is a PDCCH candidate that uses a given DCI format.

In one embodiment, any PDCCH candidate monitored in the first time window is a PDCCH candidate that uses one or more DCI Payload Sizes.

In one embodiment, any PDCCH candidate monitored in the first time window is a PDCCH candidate that uses a given DCI Payload Size.

In one embodiment, a subcarrier spacing (SCS) configured for a BWP to which at least one PDCCH candidate monitored in the first time window belongs in frequency domain is equal to the first subcarrier spacing.

In one embodiment, a subcarrier spacing (SCS) configured for an active BWP in a serving cell to which at least one PDCCH candidate monitored in the first time window belongs is equal to the first subcarrier spacing.

In one embodiment, a subcarrier spacing (SCS) configured for an active BWP in a Scheduling Cell to which at least one PDCCH candidate monitored in the first time window belongs is equal to the first subcarrier spacing.

In one embodiment, further comprising:
receiving a first synchronization signal;
wherein the first synchronization signal is used to determine a position of the first time window in time domain.

In one embodiment, further comprising:
receiving a first synchronization signal;
wherein the first synchronization signal is used to determine timing of the first time window.

In one embodiment, the target DCI format set only comprises 1 DCI format.

In one embodiment, the target DCI format set only comprises two DCI formats.

In one embodiment, the target DCI format set comprises more than two DCI formats.

In one embodiment, the target DCI format set is configurable.

In one embodiment, all or part of the first information block is used for explicitly or implicitly indicating the target DCI format set.

In one embodiment, a signaling other than the first information block is used for explicitly or implicitly indicating the target DCI format set.

In one embodiment, the target DCI format set comprises 1 DCI format scheduling Physical Downlink Shared Channel (PDSCH) and 1 DCI format scheduling Physical Uplink Shared Channel (PUSCH).

In one embodiment, the target DCI format set comprises C1 DCI formats scheduling Physical Downlink Shared Channel (PDSCH) and C1 DCI formats scheduling Physical Uplink Shared Channel (PUSCH), where C1 is a positive integer greater than 1.

In one embodiment, the target DCI format set comprises a format 0_K and a format 1_K, where K is a positive integer greater than 2. In one subembodiment of the above embodiment, K is equal to 3, or is equal to 4, or is equal to 5.

In one embodiment, the target DCI format set comprises a format 0_K and a format 1_K, where K is a positive integer greater than 2; the target DCI format set comprises one of a format 0_0, a format 0_1, a format 0_2, a format 1_0, a format 1_1 or a format 1_2, or a combination of some of these formats. In one subembodiment of the above embodiment, K is equal to 3, or is equal to 4, or is equal to 5.

In one embodiment, the target DCI format set comprises a format 0_K and a format 1_K, where K is a positive integer greater than 2; the format 0_K and the format 1_K have equal payload sizes. In one subembodiment of the above embodiment, K is equal to 3, or is equal to 4, or is equal to 5.

In one embodiment, the target DCI format set is related to capabilities of the first node in the present application.

In one embodiment, whether the target DCI format set comprises any DCI format other than DCI format(s) capable of scheduling multiple cells simultaneously is related to capabilities of the first node in the present application.

In one embodiment, the target DCI format set only comprises DCI format(s) capable of scheduling multiple cells simultaneously.

In one embodiment, the target DCI format set comprises DCI format(s) capable of scheduling multiple cells simultaneously and DCI format(s) other than the DCI format(s) capable of scheduling multiple cells simultaneously.

In one embodiment, the target DCI format set is configured by a configuration signaling of a search space in a scheduling cell of at least one cell comprised by the first cell set.

In one embodiment, all or part of an IE “searchspace” in a scheduling cell of at least one cell comprised by the first cell set is used to determine the target DCI format set.

In one embodiment, all or part of an IE “searchspace” for a scheduling cell of at least one cell comprised by the first cell set is used to determine the target DCI format set.

In one embodiment, all or part of an IE “searchspace” for one cell comprised by the first cell set is used to determine the target DCI format set.

In one embodiment, all or part of an IE “searchspace” for the reference cell is used to determine the target DCI format set.

In one embodiment, all or part of a configuration signaling that belongs to a BWP in a scheduling cell of at least one cell comprised by the first cell set is used to determine the target DCI format set.

In one embodiment, all or part of a configuration signaling that belongs to a BWP in at least one cell comprised by the first cell set is used to determine the target DCI format set.

In one embodiment, all or part of a configuration signaling that belongs to a BWP in a reference cell is used to determine the target DCI format set.

In one embodiment, a DCI format for the first cell set is a DCI format for all cells in the first cell set.

In one embodiment, a DCI format for the first cell set is a DCI format capable of simultaneously scheduling multiple PDSCHs or multiple PUSCHs respectively on multiple cells.

In one embodiment, a DCI format for the first cell set is a DCI format capable of simultaneously scheduling multiple PDSCHs or multiple PUSCHs respectively on multiple cells comprised by the first cell set.

In one embodiment, a DCI format for the first cell set is a DCI format by which an upper limit of a number of cells scheduled simultaneously is greater than 1.

In one embodiment, an upper limit of a number of cells comprised by the first cell set that a DCI format for the first cell set is used for scheduling simultaneously is greater than 1.

In one embodiment, a DCI format for the first cell set can be used for simultaneously scheduled one or more cells.

In one embodiment, a maximum value of a number of cells simultaneously scheduled by a DCI format for the first cell set is greater than 1.

In one embodiment, a maximum value of a number of cells that a PDCCH carrying a DCI format for the first cell set is used for scheduling simultaneously is greater than 1.

In one embodiment, a number of cells that a DCI format for the first cell set is configured by a higher-layer signaling to schedule is greater than 1.

In one embodiment, a number of cell(s) that a DCI format for the first cell set actually schedules simultaneously is equal to or greater than 1.

In one embodiment, a number of cells that a DCI format for the first cell set is configured by a higher-layer signaling to schedule is greater than 1, and a DCI format for the first cell set is used for explicitly or implicitly indicating a number of cells actually being scheduled simultaneously.

In one embodiment, a DCI format for the first cell set is a DCI format used for scheduling PDSCH(s) or PUSCH(s) on cells comprised by the first cell set.

In one embodiment, a DCI format for the first cell set is a DCI format that a PDCCH candidate for the first cell set is assumed to carry.

In one embodiment, a DCI format for the first cell set is configured in a UE specific search (USS).

In one embodiment, a DCI format for the first cell set is a DCI format for an identity value or indication value or index value for the first cell set.

In one embodiment, a DCI format for the first cell set is a DCI format for a na value corresponding to the first cell set.

In one embodiment, a DCI format for the first cell set is a DCI format for a CIF value corresponding to the first cell set.

In one embodiment, a DCI format for the first cell set is a DCI format assumed to be carried by a PDCCH candidate determined according to an identity value or indication value or index value of the first cell set.

In one embodiment, a DCI format for the first cell set is a DCI format assumed to be carried by a PDCCH candidate determined according to a na value corresponding to the first cell set.

In one embodiment, a DCI format for the first cell set is a DCI format assumed to be carried by a PDCCH candidate determined according to a CIF value corresponding to the first cell set.

In one embodiment, a DCI format for the first cell set refers to: a DCI format configured by a configuration signaling of a search space in a scheduling cell of at least one cell comprised by the first cell set.

In one embodiment, a DCI format for the first cell set refers to: a DCI format configured by all or part of an IE “searchspace” in a scheduling cell of at least one cell comprised by the first cell set.

In one embodiment, a DCI format for the first cell set refers to: a DCI format configured by all or part of an IE “searchspace” for a scheduling cell of at least one cell comprised by the first cell set.

In one embodiment, a DCI format for the first cell set refers to: a DCI format configured by all or part of an IE “searchspace” for one cell comprised by the first cell set.

In one embodiment, a DCI format for the first cell set refers to: a DCI format configured by all or part of an IE “searchspace” for the reference cell.

In one embodiment, a DCI format for the first cell set refers to: a DCI format configured by all or part of a configuration signaling that belongs to a BWP in a scheduling cell of at least one cell comprised by the first cell set.

In one embodiment, a DCI format for the first cell set refers to: a DCI format configured by all or part of a configuration signaling that belongs to a BWP in at least one cell comprised by the first cell set.

In one embodiment, a DCI format for the first cell set refers to: a DCI format configured by all or part of a configuration signaling that belongs to a BWP in a reference cell.

In one embodiment, a DCI format for the first cell set refers to: a DCI format configured in a search space for a scheduling cell that has an identity value (or index value) equal to that of a search space for one cell in the first cell set.

In one embodiment, the technical feature that “the target DCI format set comprising at least one DCI format for the first cell set” includes the following meaning: the target DCI format set comprises at least one DCI format for all cells in the first cell set.

In one embodiment, the technical feature that “the target DCI format set comprising at least one DCI format for the first cell set” includes the following meaning: any DCI format comprised by the target DCI format set is a DCI format for the first cell set.

In one embodiment, the technical feature that “the target DCI format set comprising at least one DCI format for the first cell set” includes the following meaning: the target DCI format set comprises one DCI format that is a DCI format for one or more cells other than the first cell set.

In one embodiment, part or all of the first information block is used for explicitly or implicitly determining at least one said PDCCH candidate for DCI format(s) in the target DCI format set.

In one embodiment, a signaling other than the first information block is used for determining at least one said PDCCH candidate for DCI format(s) in the target DCI format set.

In one embodiment, a PDCCH configuration signaling is used for determining at least one said PDCCH candidate for DCI format(s) in the target DCI format set.

In one embodiment, any PDCCH candidate for DCI format(s) in the target DCI format set is a Monitored PDCCH Candidate.

In one embodiment, any PDCCH candidate for DCI format(s) in the target DCI format set is a PDCCH candidate for at least one DCI format in the target DCI format set.

In one embodiment, any PDCCH candidate for DCI format(s) in the target DCI format set is a PDCCH candidate for payload size(s) of at least one DCI format in the target DCI format set.

In one embodiment, a number of CCEs occupied by any PDCCH candidate for DCI format(s) in the target DCI format set is equal to an aggregation level (AL) of the PDCCH candidate.

In one embodiment, any CCE occupied by any PDCCH candidate for DCI format(s) in the target DCI format set comprises 6 resource element groups (REGs).

In one embodiment, any CCE occupied by any PDCCH candidate for DCI format(s) in the target DCI format set comprises REs occupied by a PDCCH demodulation reference signal (DMRS).

In one embodiment, any PDCCH candidate for DCI format(s) in the target DCI format set is a PDCCH candidate assumed to be carrying at least one DCI format in the target DCI format set.

In one embodiment, any PDCCH candidate for DCI format(s) in the target DCI format set is a PDCCH candidate of which blind detection is performed according to payload size(s) of at least one DCI format in the target DCI format set.

In one embodiment, any PDCCH candidate for DCI format(s) in the target DCI format set is a PDCCH candidate of which decoding is performed according to payload size(s) of at least one DCI format in the target DCI format set.

In one embodiment, any PDCCH candidate for DCI format(s) in the target DCI format set is a PDCCH candidate monitored for reception of one DCI format in the target DCI format set.

In one embodiment, any PDCCH candidate for DCI format(s) in the target DCI format set is a PDCCH candidate for at least one DCI format for the first cell set in the target DCI format set.

In one embodiment, any PDCCH candidate for DCI format(s) in the target DCI format set is a PDCCH candidate for at least one DCI format in the target DCI format set that can be used for scheduling multiple cells simultaneously.

In one embodiment, any PDCCH candidate for DCI format(s) in the target DCI format set is a PDCCH candidate for at least one DCI format in the target DCI format set that can be used for simultaneously scheduling multiple PDSCHs or multiple PUSCHs respectively on multiple cells.

In one embodiment, any PDCCH candidate monitored for the reference cell is a PDCCH candidate that schedules at least the reference cell.

In one embodiment, any PDCCH candidate monitored for the reference cell is a PDCCH candidate that schedules the reference cell or a cell set that comprises the reference cell.

In one embodiment, any PDCCH candidate monitored for the reference cell is a PDCCH candidate that schedules at least a PDSCH or a PUSCH on the reference cell.

In one embodiment, any PDCCH candidate monitored for the reference cell is a PDCCH candidate counted for calculating an upper limit of PDCCH candidates and an upper limit of non-overlapped CCEs for the reference cell.

In one embodiment, any PDCCH candidate monitored for the reference cell is a PDCCH candidate regarded to be only scheduling a PDSCH or a PUSCH on the reference cell.

In one embodiment, the technical feature that “a PDCCH candidate monitored for a DCI format in the target DCI format set is counted for PDCCH candidates monitored for the reference cell” includes the following meaning:

a PDCCH candidate for a DCI format scheduling multiple cells being monitored is only counted for PDCCH candidates monitored for a scheduled cell.

In one embodiment, the technical feature that “a PDCCH candidate monitored for a DCI format in the target DCI format set is counted for PDCCH candidates monitored for the reference cell” includes the following meaning: each PDCCH candidate for the first cell set being monitored is counted for PDCCH candidates monitored for the reference cell.

In one embodiment, the technical feature that “a PDCCH candidate monitored for a DCI format in the target DCI format set is counted for PDCCH candidates monitored for the reference cell” includes the following meaning: each PDCCH candidate for the first cell set being monitored is regarded as a PDCCH candidate monitored for the reference cell.

In one embodiment, the technical feature that “a PDCCH candidate monitored for a DCI format in the target DCI format set is counted for PDCCH candidates monitored for the reference cell” includes the following meaning: each PDCCH candidate for multiple cells in the first cell set being monitored is counted for PDCCH candidates monitored for the reference cell.

In one embodiment, the technical feature that “a PDCCH candidate monitored for a DCI format in the target DCI format set is counted for PDCCH candidates monitored for the reference cell” includes the following meaning: a PDCCH candidate for a DCI format in the target DCI format set being monitored is only counted for PDCCH candidates monitored for the reference cell.

In one embodiment, the technical feature that “a PDCCH candidate monitored for a DCI format in the target DCI format set is counted for PDCCH candidates monitored for the reference cell” includes the following meaning:

a PDCCH candidate for a DCI format in the target DCI format set being monitored is not counted for PDCCH candidates monitored for any cell other than the reference cell.

In one embodiment, the technical feature that “a PDCCH candidate monitored for a DCI format in the target DCI format set is counted for PDCCH candidates monitored for the reference cell” includes the following meaning: a PDCCH candidate for a DCI format in the target DCI format set being monitored is counted for a number of times of monitoring of PDCCH candidates for the reference cell.

In one embodiment, the technical feature that “a PDCCH candidate monitored for a DCI format in the target DCI format set is counted for PDCCH candidates monitored for the reference cell” includes the following meaning: a PDCCH candidate for a DCI format in the target DCI format set being monitored has an influence on a budget of PDCCH candidates for the reference cell.

In one embodiment, the technical feature that “a PDCCH candidate monitored for a DCI format in the target DCI format set is counted for PDCCH candidates monitored for the reference cell” includes the following meaning: a number of times of monitoring of a PDCCH candidate for a DCI format in the target DCI format set is counted for a number of times of monitoring of PDCCH candidates for the reference cell.

In one embodiment, the technical feature that “a PDCCH candidate monitored for a DCI format in the target DCI format set is counted for PDCCH candidates monitored for the reference cell” includes the following meaning: a number of the PDCCH candidate(s) monitored for a DCI format in the target DCI format set has an influence on a budget of PDCCH candidates for the reference cell.

In one embodiment, the technical feature that “a PDCCH candidate monitored for a DCI format in the target DCI format set is counted for PDCCH candidates monitored for the reference cell” includes the following meaning: a number of the PDCCH candidate(s) monitored for a DCI format in the target DCI format set is counted for a total number of times of monitoring of PDCCH candidates for the reference cell.

In one embodiment, that a PDCCH candidate is not counted for PDCCH candidates monitored for the reference cell means that monitoring of the PDCCH candidate does not influence the counting of a total number of times of PDCCH candidate monitoring for the reference cell, or that the monitoring of the PDCCH candidate is counted as 0 monitoring for the total number of times of PDCCH candidate monitoring for the reference cell, or that the monitoring of the PDCCH candidate does not require an independent decoding.

In one embodiment, the first threshold is equal to M_{PDCCH}^{total,slot,μ}, where μ represents an index of the first subcarrier spacing and the first time window is a slot.

In one embodiment, the first threshold is equal to min(M_{PDCCH}^{max,slot,μ},M_{PDCCH}^{total,slot,μ}), where μ represents an index of the first subcarrier spacing and the first time window is a slot.

In one embodiment, the first threshold is equal to min(γ,M_{PDCCH}^{max,slot,μ},M_{PDCCH}^{total,slot,μ}), where μ represents an index of the first subcarrier spacing and the first time window is a slot, and γ represents a factor indicated by a capability report of the first node.

In one embodiment, the first threshold is equal to M_{PDCCH}^{total,(X,Y),μ}, where μ represents index of the first subcarrier spacing and the first time window is a slot.

In one embodiment, the first threshold is equal to min(M_{PDCCH}^{max,(X,Y),μ},M_{PDCCH}^{total,(X,Y),μ}), where μ represents an index of the first subcarrier spacing and the first time window is X time-domain consecutive multicarrier symbols.

In one embodiment, the second threshold is equal to C_{PDCCH}^{total,slot,μ}, where μ represents an index of the first subcarrier spacing and the first time window is a slot.

In one embodiment, the second threshold is equal to min(C_{PDCCH}^{max,slot,μ},C_{PDCCH}^{total,slot,μ}), where μ represents an index of the first subcarrier spacing and the first time window is a slot.

In one embodiment, the second threshold is equal to min(γ·C_{PDCCH}^{max,slot,μ},C_{PDCCH}^{total,slot,μ}) where μ represents an index of the first subcarrier spacing and the first time window is a slot, and γ represents a factor indicated by a capability report of the first node.

In one embodiment, the second threshold is equal to C_{PDCCH}^{total,(X,Y),μ}, where μ represents an index of the first subcarrier spacing and the first time window is a slot.

In one embodiment, the second threshold is equal to min (C_{PDCCH}^{max,(X,Y),μ}, C_{PDCCH}^{total,(X,Y),μ}) where μ represents an index of the first subcarrier spacing and the first time window is X time-domain consecutive multicarrier symbols.

In one embodiment, the first threshold and the second threshold may or may not be equal.

In one embodiment, the first threshold and the second threshold are mutually independent.

In one embodiment, the first threshold and the second threshold are unrelated.

In one embodiment, the first threshold and the second threshold are related.

In one embodiment, the first threshold and the second threshold are linearly correlated.

In one embodiment, there is a proportional relationship between the first threshold and the second threshold.

In one embodiment, a number of PDCCH candidates monitored for the reference cell within the first time window is a number of PDCCH candidates for the reference cell being monitored on a scheduling cell of the reference cell which has an active BWP and uses the first subcarrier spacing within the first time window.

In one embodiment, statements that “a number of PDCCH candidates monitored for the reference cell within the first time window” and “a total number of times of blind detection or blind decoding of PDCCHs for the reference cell for one or more DCI formats within the first time window” have equivalent meaning or are mutually replaceable.

In one embodiment, statements that “a number of PDCCH candidates using the first subcarrier spacing monitored within the first time window” and “a total number of times of PDCCH candidate monitoring performed for the reference cell within the first time window” have equivalent meaning or are mutually replaceable.

In one embodiment, a number of PDCCH candidates monitored for the reference cell within the first time window is configured.

In one embodiment, a number of PDCCH candidates monitored for the reference cell within the first time window is configured in a configuration signaling of a search space of the reference cell.

In one embodiment, any two PDCCH candidates monitored for the reference cell within the first time window have different characteristic attributes, where the characteristic attributes include at least one of occupied CCEs, used Scrambling, or a corresponding DCI Payload Size.

In one embodiment, two PDCCH candidates having identical characteristic attribute(s) are not simultaneously counted for a number of PDCCH candidates being monitored, where the characteristic attributes include at least one of occupied CCEs, used Scrambling, or a corresponding DCI Payload Size.

In one embodiment, two PDCCH candidates having identical characteristic attribute(s) are not simultaneously counted for a number of PDCCH candidates being monitored, where the characteristic attributes include at least one of occupied CCEs, used Scrambling, or a corresponding DCI Payload Size.

In one embodiment, of two PDCCH candidates having identical characteristic attribute(s) only one PDCCH candidate is counted for a number of PDCCH candidates being monitored, where the characteristic attributes include at least one of occupied CCEs, used Scrambling, or a corresponding DCI Payload Size.

In one embodiment, statements that “a number of PDCCH candidates monitored for the reference cell in the first time window is no greater than a first threshold” and “the first node is not required to monitor PDCCH candidates for the reference cell of which the number exceeds the first threshold in the first time window” have equivalent meaning or are mutually replaceable.

In one embodiment, statements that “a number of PDCCH candidates monitored for the reference cell in the first time window is no greater than a first threshold” and “the first node does not expect that a number of PDCCH candidates for the reference cell monitored in the first time window exceeds the first threshold” have equivalent meaning or are mutually replaceable.

In one embodiment, the network side ensures during its configuration that a number of PDCCH candidates for the reference cell monitored in the first time window does not exceed the first threshold.

In one embodiment, when the reference cell is a primary cell and a number of PDCCH candidates for the reference cell configured within the first time window exceeds the first threshold, part of the PDCCH candidates for the reference cell configured within the first time window is/are dropped.

In one embodiment, when the reference cell is a primary cell and a number of PDCCH candidates for the reference cell configured within the first time window exceeds the first threshold, part of the PDCCH candidates for the reference cell configured within the first time window is/are not monitored.

In one embodiment, a number of PDCCH candidates monitored for the reference cell within the first time window is less than the first threshold.

In one embodiment, a number of PDCCH candidates monitored for the reference cell within the first time window can be equal to the first threshold.

In one embodiment, non-overlapped CCEs for the reference cell in the first time window are non-overlapped CCEs for the reference cell on a scheduling cell of the reference cell in the first time window.

In one embodiment, statements that “a number of non-overlapped CCEs for the reference cell in the first time window” and “a number of non-overlapped CCEs monitored for the reference cell in the first time window” have equivalent meaning or are mutually replaceable.

In one embodiment, statements that “a number of non-overlapped CCEs for the reference cell in the first time window” and “a total number of non-overlapped CCEs for the reference cell monitored on a scheduling cell of the reference cell in the first time window” have equivalent meaning or are mutually replaceable.

In one embodiment, statements that “a number of non-overlapped CCEs for the reference cell in the first time window” and “a total number of non-overlapped CCEs occupied by PDCCH candidate(s) for the reference cell in the first time window” have equivalent meaning or are mutually replaceable.

In one embodiment, statements that “a number of non-overlapped CCEs for the reference cell in the first time window” and “a total number of non-overlapped CCEs for the reference cell by which time-domain resources occupied belong to the first time window” have equivalent meaning or are mutually replaceable.

In one embodiment, when two CCEs correspond to different CORESET indexes or correspond to different start time-domain symbols for receptions of respectively corresponding PDCCH candidates, the two CCEs are non-overlapped.

In one embodiment, statements that “a number of non-overlapped CCEs for the reference cell in the first time window is no greater than a second threshold” and “the first node is not required to monitor non-overlapped CCEs for the reference cell of which the number exceeds the second threshold in the first time window” have equivalent meaning or are mutually replaceable.

In one embodiment, statements that “a number of non-overlapped CCEs for the reference cell in the first time window is no greater than a second threshold” and “the first node does not expect that a number of non-overlapped CCEs for the reference cell monitored in the first time window exceeds the second threshold” have equivalent meaning or are mutually replaceable.

In one embodiment, the network side ensures during its configuration that a number of non-overlapped CCEs for the reference cell monitored in the first time window does not exceed the second threshold.

In one embodiment, when the reference cell is a primary cell and a number of non-overlapped CCEs for the reference cell configured within the first time window exceeds the second threshold, part of the PDCCH candidates for the reference cell configured within the first time window is/are dropped.

In one embodiment, when the reference cell is a primary cell and a number of non-overlapped CCEs for the reference cell configured within the first time window exceeds the second threshold, part of the PDCCH candidates for the reference cell configured within the first time window is/are not monitored.

In one embodiment, a number of non-overlapped CCEs for the reference cell in the first time window is less than the second threshold.

In one embodiment, a number of non-overlapped CCEs for the reference cell in the first time window can be equal to the second threshold.

In one embodiment, the first subcarrier spacing is measured in Hz.

In one embodiment, the first subcarrier spacing is measured in kHz.

In one embodiment, the first subcarrier spacing is equal to one of 15 kHz, 30 kHz, 60 kHz, 120 kHz, 240 kHz, or 480 kHz.

In one embodiment, the first time window comprises at least one time-domain consecutive multicarrier symbol corresponding to the first subcarrier spacing.

In one embodiment, when the first time window comprises more than one multicarrier symbol, any two multicarrier symbols comprised by the first time window are of an equal time length.

In one embodiment, when the first time window comprises more than one multicarrier symbol, the first time window comprises two multicarrier symbols of unequal time lengths.

In one embodiment, the first subcarrier spacing is configured by signaling.

In one embodiment, the first subcarrier spacing is equal to a subcarrier spacing configured for a bandwidth part (BWP) to which at least one PDCCH candidate for DCI format(s) in the target DCI format set that is(are) monitored in the first time window belongs in frequency domain.

In one embodiment, a subcarrier spacing of any subcarrier occupied by at least one PDCCH candidate for DCI format(s) in the target DCI format set that is(are) monitored in the first time window in frequency domain is equal to the first subcarrier spacing.

In one embodiment, the above sentence that “the first subcarrier spacing being used to determine a time length of one multicarrier symbol comprised by the first time window” includes the following meaning: the first subcarrier spacing is used by the first node in the present application to determine a time length of one multicarrier symbol comprised by the first time window

In one embodiment, the above sentence that “the first subcarrier spacing being used to determine a time length of one multicarrier symbol comprised by the first time window” includes the following meaning: the first subcarrier spacing is used to determine a time length of any multicarrier symbol comprised by the first time window.

In one embodiment, the above sentence that “the first subcarrier spacing being used to determine a time length of one multicarrier symbol comprised by the first time window” includes the following meaning: the first subcarrier spacing is used to determine a time length of any multicarrier symbol comprised by the first time window according to a mapping relationship.

In one embodiment, the above sentence that “the first subcarrier spacing being used to determine a time length of one multicarrier symbol comprised by the first time window” includes the following meaning: the first subcarrier spacing is used to determine a number of multicarrier symbols comprised by a subframe to which the first time window belongs, where the number of multicarrier symbols comprised by the subframe to which the first time window belongs is used to determine a time length of one multicarrier symbol comprised by the first time window.

In one embodiment, the above sentence that “the first subcarrier spacing being used to determine a time length of one multicarrier symbol comprised by the first time window” includes the following meaning: the first subcarrier spacing is used to determine a number of slots comprised by a subframe to which the first time window belongs, where the number of slots comprised by the subframe to which the first time window belongs is used to determine a time length of one multicarrier symbol comprised by the first time window.

In one embodiment, the above sentence that “the first subcarrier spacing being used to determine a time length of one multicarrier symbol comprised by the first time window” includes the following meaning: a Configuration Index of the first subcarrier spacing is used to determine a time length of any multicarrier symbol comprised by the first time window.

In one embodiment, the first threshold is dependent on a time length of the first time window.

In one embodiment, the second threshold is dependent on a time length of the first time window.

In one embodiment, the first threshold is dependent on whether the first time window is a slot or a span.

In one embodiment, the second threshold is dependent on whether the first time window is a slot or a span.

In one embodiment, the first threshold is dependent on whether the first time window is a slot or a span, and when the first time window is a span, the first threshold is also dependent on a combination corresponding to the first time window.

In one embodiment, the second threshold is dependent on whether the first time window is a slot or a span, and when the first time window is a span, the second threshold is also dependent on a combination corresponding to the first time window.

In one embodiment, the technical feature that “the first threshold is related to the first subcarrier spacing” includes the following meaning: the first subcarrier spacing is used for determining or calculating the first threshold.

In one embodiment, the technical feature that “the second threshold is related to the first subcarrier spacing” includes the following meaning: the first subcarrier spacing is used for determining or calculating the second threshold.

In one embodiment, the technical feature that “the first threshold is related to the first subcarrier spacing” includes the following meaning: there is a pre-defined mapping or corresponding relation between the first subcarrier spacing and the first threshold.

In one embodiment, the technical feature that “the second threshold is related to the first subcarrier spacing” includes the following meaning: there is a pre-defined mapping or corresponding relation between the first subcarrier spacing and the second threshold.

In one embodiment, the technical feature that “the first threshold is related to the first subcarrier spacing” includes the following meaning: there is a pre-defined table-based corresponding relation between the first subcarrier spacing and the first threshold.

In one embodiment, the technical feature that “the second threshold is related to the first subcarrier spacing” includes the following meaning: there is a pre-defined table-based corresponding relation between the first subcarrier spacing and the second threshold.

In one embodiment, the technical feature that “the first threshold is related to the first subcarrier spacing” includes the following meaning: a first intermediate parameter is used for calculating the first threshold, the first intermediate parameter being related to the first subcarrier spacing.

In one embodiment, the technical feature that “the second threshold is related to the first subcarrier spacing” includes the following meaning: a second intermediate parameter is used for calculating the second threshold, the second intermediate parameter being related to the first subcarrier spacing.

In one embodiment, the technical feature that “the first threshold is related to the first subcarrier spacing” includes the following meaning: the first subcarrier spacing is a candidate subcarrier spacing of Y1 candidate subcarrier spacings, where Y1 is a positive integer greater than 1; the Y1 candidate subcarrier spacings respectively correspond to Y1 first-type candidate quantity values, and any first-type candidate quantity value among the Y1 first-type candidate quantity values is a positive integer, where the first threshold is equal to a first-type candidate quantity value corresponding to the first subcarrier spacing among the Y1 first-type candidate quantity values. In one subsidiary embodiment of the above embodiment, the one-to-one correspondence relation between the Y1 candidate subcarrier spacings and the Y1 first-type candidate quantity values is pre-defined. In one subsidiary embodiment of the above embodiment, the one-to-one correspondence relation between the Y1 candidate subcarrier spacings and the Y1 first-type candidate quantity values is configured. In one subsidiary embodiment of the above embodiment, the one-to-one correspondence relation between the Y1 candidate subcarrier spacings and the Y1 first-type candidate quantity values is related to a length of the first time window.

In one embodiment, the technical feature that “the first threshold is related to the first subcarrier spacing” includes the following meaning: the first subcarrier spacing is a candidate subcarrier spacing of Y1 candidate subcarrier spacings, where Y1 is a positive integer greater than 1; the Y1 candidate subcarrier spacings respectively correspond to Y1 first-type candidate quantity values, and any first-type candidate quantity value among the Y1 first-type candidate quantity values is a positive integer, where the first threshold is equal to a smaller value between a first-type candidate quantity value corresponding to the first subcarrier spacing among the Y1 first-type candidate quantity values and a first intermediate value, the first intermediate value being related to capabilities of the first node.

In one subsidiary embodiment of the above embodiment, the one-to-one correspondence relation between the Y1 candidate subcarrier spacings and the Y1 first-type candidate quantity values is pre-defined. In one subsidiary embodiment of the above embodiment, the one-to-one correspondence relation between the Y1 candidate subcarrier spacings and the Y1 first-type candidate quantity values is configured. In one subsidiary embodiment of the above embodiment, the one-to-one correspondence relation between the Y1 candidate subcarrier spacings and the Y1 first-type candidate quantity values is related to a length of the first time window.

In one embodiment, the technical feature that “the second threshold is related to the first subcarrier spacing” includes the following meaning: the first subcarrier spacing is a candidate subcarrier spacing of Y1 candidate subcarrier spacings, where Y1 is a positive integer greater than 1; the Y1 candidate subcarrier spacings respectively correspond to Y1 second-type candidate quantity values, and any second-type candidate quantity value among the Y1 second-type candidate quantity values is a positive integer, where the second threshold is equal to a second-type candidate quantity value corresponding to the first subcarrier spacing among the Y1 second-type candidate quantity values. In one subsidiary embodiment of the above embodiment, the one-to-one correspondence relation between the Y1 candidate subcarrier spacings and the Y1 second-type candidate quantity values is pre-defined. In one subsidiary embodiment of the above embodiment, the one-to-one correspondence relation between the Y1 candidate subcarrier spacings and the Y1 second-type candidate quantity values is configured. In one subsidiary embodiment of the above embodiment, the one-to-one correspondence relation between the Y1 candidate subcarrier spacings and the Y1 second-type candidate quantity values is related to a length of the first time window.

In one embodiment, the technical feature that “the second threshold is related to the first subcarrier spacing” includes the following meaning: the first subcarrier spacing is a candidate subcarrier spacing of Y1 candidate subcarrier spacings, where Y1 is a positive integer greater than 1; the Y1 candidate subcarrier spacings respectively correspond to Y1 second-type candidate quantity values, and any second-type candidate quantity value among the Y1 second-type candidate quantity values is a positive integer, where the second threshold is equal to a smaller value between a second-type candidate quantity value corresponding to the first subcarrier spacing among the Y1 second-type candidate quantity values and a second intermediate value, the second intermediate value being related to capabilities of the first node. In one subsidiary embodiment of the above embodiment, the one-to-one correspondence relation between the Y1 candidate subcarrier spacings and the Y1 second-type candidate quantity values is pre-defined. In one subsidiary embodiment of the above embodiment, the one-to-one correspondence relation between the Y1 candidate subcarrier spacings and the Y1 second-type candidate quantity values is configured. In one subsidiary embodiment of the above embodiment, the one-to-one correspondence relation between the Y1 candidate subcarrier spacings and the Y1 second-type candidate quantity values is related to a length of the first time window.

In one embodiment, a CIF value corresponding to a cell other than the reference cell is used to determine a CCE occupied by the at least one PDCCH candidate monitored using DCI format(s) in the target DCI format set.

In one embodiment, an identity value or index value of the first cell set is used to determine a CCE occupied by the at least one PDCCH candidate monitored using DCI format(s) in the target DCI format set.

In one embodiment, a CIF value individually configured for the first cell set is used to determine a CCE occupied by the at least one PDCCH candidate monitored using DCI format(s) in the target DCI format set.

In one embodiment, size(s) of at least one DCI format in the target DCI format set is(are) related to a number of cells comprised by the first cell set.

In one embodiment, size(s) of at least one DCI format in the target DCI format set is(are) related to capabilities of the first node.

In one embodiment, size(s) of at least one DCI format in the target DCI format set is(are) related to the first parameter in the present application.

In one embodiment, a reference scheduling cell is a scheduling cell of the first cell set, and a characteristic identity value is equal to an identity value of a search space configured for the reference scheduling cell, where a number of PDCCH candidates using a given aggregation level (AL) that are configured for a search space for a given cell in the first cell set and with an identity value equal to the characteristic identity value is used to determine a number of PDCCH candidates using the given AL for the first cell set comprised by a search space configured for the reference scheduling cell.

In one embodiment, a reference scheduling cell is a scheduling cell of the first cell set, and a characteristic identity value is equal to an identity value of a search space configured for the reference scheduling cell, where a number of PDCCH candidates using a given aggregation level (AL) that are configured for a search space for the reference cell and with an identity value equal to the characteristic identity value is used to determine a number of PDCCH candidates using the given AL for the first cell set comprised by a search space configured for the reference scheduling cell.

### Embodiment 2

Embodiment 2 illustrates a schematic diagram of a network architecture according to the present application, as shown in FIG. 2. FIG. 2 is a diagram illustrating a network architecture 200 of 5G NR, Long-Term Evolution (LTE) and Long-Term Evolution Advanced (LTE-A) systems. The 5G NR or LTE network architecture 200 may be called 5G System/Evolved Packet System (5GS/EPS) 200 or other appropriate terms. The 5GS/EPS 200 may comprise one or more UEs 201, an NG-RAN 202, a 5G-Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN 202 comprises an NR/evolved node B (gNB/eNB) 203 and other gNBs(eNBs) 204. The gNB(eNB) 203 provides UE 201 oriented user plane and control plane terminations. The gNB(eNB) 203 may be connected to other gNBs(eNBs) 204 via an Xn/X2 interface (for example, backhaul). The gNB(eNB) 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB(eNB) 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB(eNB) 203 is connected with the 5G-CN/EPC 210 via an S1/NG interface. The 5G-CN/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the gNB(eNB) 203 corresponds to the second node in the present application.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 used for a first node (UE or gNB) and a second node (gNB or UE) is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between the first node and the second node via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second nodes of the network side. The PDCP sublayer 304 provides multiplexing among variable radio bearers and logical channels. The PDCP sublayer 304 provides security by encrypting a packet and provides support for handover of a first node between second nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second node and the first node. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

### Embodiment 4

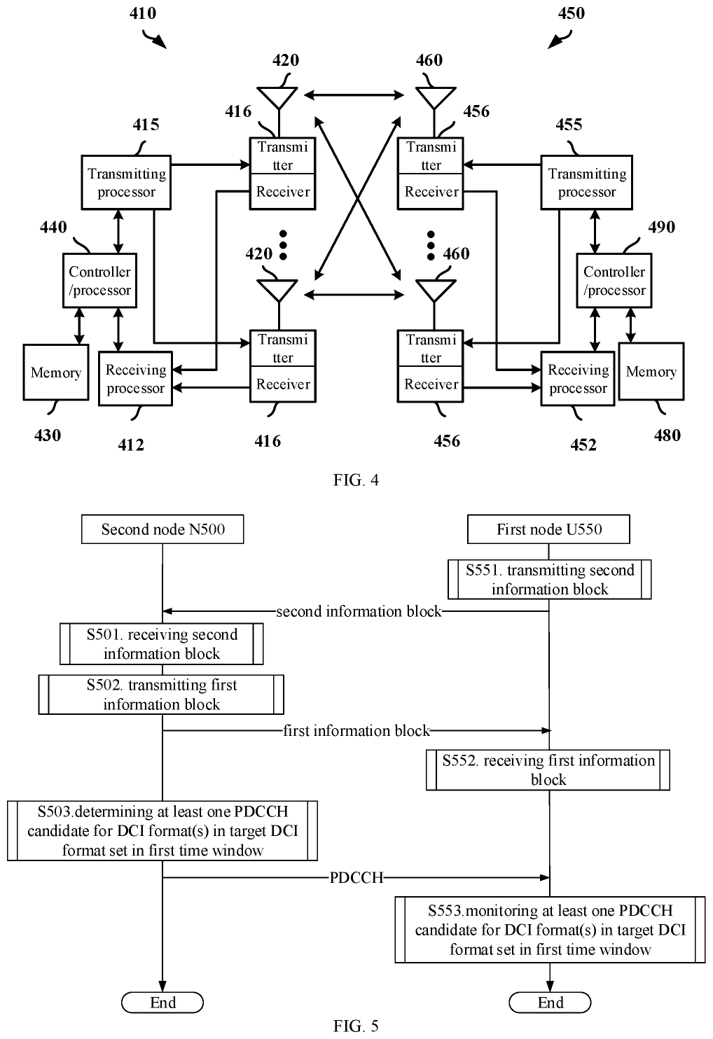

Embodiment 4 illustrates a schematic diagram of a first node and a second node according to one embodiment of the present application, as shown in FIG. 4.

The first node (450) can comprise a controller/processor 490, a data source/buffer 480, a receiving processor 452, a transmitter/receiver 456 and a transmitting processor 455, where the transmitter/receiver 456 comprises an antenna 460.

The second node (410) can comprise a controller/processor 440, a data source/buffer 430, a receiving processor 412, a transmitter/receiver 416 and a transmitting processor 415, where the transmitter/receiver 416 comprises an antenna 420.

In Downlink (DL), a higher layer packet, for instance including higher-layer information contained in the first information block in the present application, is provided to the controller/processor 440. The controller/processor 440 provides functions of the L2 layer and above. In DL, the controller/processor 440 provides header compression, encryption, packet segmentation and reordering, multiplexing between a logical channel and a transport channel as well as radio resources allocation for the first node 450 based on various priorities. The controller/processor 440 is also responsible for HARQ operation, a retransmission of a lost packet and a signaling to the first node 450, for instance, higher-layer information carried in the first information block is generated in the controller/processor 440. The transmitting processor 415 performs various signal processing functions used for the L1 (that is, PHY), including coding, interleaving, scrambling, modulating, power control/allocating, pre-coding and physical layer control signaling generation, for example, the generations of a physical-layer signal carrying the first information block in the present application and a physical-layer signal corresponding to the PDCCH in the present application are completed in the transmitting processor 415. Modulation symbols that have been generated are divided into parallel streams and each of them is mapped onto a corresponding multicarrier subcarrier and/or multicarrier symbol, and then is mapped by the transmitting processor 415 to the antenna 420 via the transmitter 416 to be transmitted in the form of radio frequency signals. At the receiving end, each receiver 456 receives a radio frequency signal via a corresponding antenna 460, and recovers baseband information modulated onto a radio frequency carrier and provides the baseband information to the receiving processor 452. The receiving processor 452 performs various signal receiving processing functions used for the L1. Signal receiving processing functions include monitoring of a physical layer signal carrying the first information block in the present application and PDCCH candidates, demodulating multicarrier symbols in multicarrier symbol streams based on various modulation schemes (i.e., BP SK, QPSK), then de-scrambling, decoding and de-interleaving to recover data or control signal transmitted by the second node 410 on a physical channel, and providing the data and control signal to the controller/processor 490. The controller/processor 490 is in charge of the L2 and above layers, the controller/processor 490 interprets higher-layer information comprised in the first information block in the present application. The controller/processor can be associated with the memory 480 that stores program code and data; the memory 480 may be called a computer readable medium.

In UL transmission, which is similar to DL, higher-layer information, including that contained in the second information block in the present application, upon generation in the controller/processor 490, is through the transmitting processor 455 to perform signal transmitting processing functions used for the L1(that is, PHY), for instance, physical layer signals carrying the second information block are generated in the transmitting processor 455, and is then mapped to the antenna 460 via the transmitter 456 from the transmitting processor 455 and transmitted in the form of radio frequency signals. The receiver 416 receives a radio frequency signal via a corresponding antenna 420, and each receiver 416 recovers baseband information modulated onto a radio frequency carrier and provides the baseband information to the receiving processor 412. The receiving processor 412 performs various signal reception processing functions used for L1 (i.e., PHY), including receiving a physical layer signal carrying the second information block and then providing data and/or control signal to the controller/processor 440. Functions of the L2 performed by the controller/processor 440 include interpreting higher-layer information, including interpreting higher-layer information carried in the second information block. The controller/processor can be associated with the buffer 430 that stores program code and data; the buffer 430 may be called a computer readable medium.

In one embodiment, the first node 450 comprises at least one processor and at least one memory, the at least one memory comprises computer program codes; The at least one memory and the computer program codes are configured to be used in collaboration with the at least one processor. The first node 450 at least receives a first information block, the first information block used for determining a reference cell, the reference cell belonging to a first cell set, the first cell set comprising multiple cells; and monitors in a first time window at least one PDCCH candidate for DCI format(s) in a target DCI format set, the target DCI format set comprising at least one DCI format for the first cell set; herein, a PDCCH candidate monitored for a DCI format in the target DCI format set is counted for PDCCH candidates monitored for the reference cell; a number of PDCCH candidates monitored for the reference cell in the first time window is no greater than a first threshold, and a number of non-overlapped CCEs for the reference cell in the first time window is no greater than a second threshold, where the first threshold is a positive integer, and the second threshold is a positive integer; a first subcarrier spacing is equal to a subcarrier spacing of at least one subcarrier occupied by the at least one PDCCH candidate monitored in the first time window for DCI format(s) in the target DCI format set in frequency domain, where the first threshold is related to the first subcarrier spacing, and the second threshold is related to the first subcarrier spacing, the first subcarrier spacing being used to determine a time length of one multicarrier symbol comprised by the first time window.

In one embodiment, the first node 450 comprises a memory that stores a computer readable instruction program, the computer readable instruction program generates actions when executed by at least one processor, which include: receiving a first information block, the first information block used for determining a reference cell, the reference cell belonging to a first cell set, the first cell set comprising multiple cells; and monitoring in a first time window at least one PDCCH candidate for DCI format(s) in a target DCI format set, the target DCI format set comprising at least one DCI format for the first cell set; herein, a PDCCH candidate monitored for a DCI format in the target DCI format set is counted for PDCCH candidates monitored for the reference cell; a number of PDCCH candidates monitored for the reference cell in the first time window is no greater than a first threshold, and a number of non-overlapped CCEs for the reference cell in the first time window is no greater than a second threshold, where the first threshold is a positive integer, and the second threshold is a positive integer; a first subcarrier spacing is equal to a subcarrier spacing of at least one subcarrier occupied by the at least one PDCCH candidate monitored in the first time window for DCI format(s) in the target DCI format set in frequency domain, where the first threshold is related to the first subcarrier spacing, and the second threshold is related to the first subcarrier spacing, the first subcarrier spacing being used to determine a time length of one multicarrier symbol comprised by the first time window.

In one embodiment, the second device 410 comprises at least one processor and at least one memory, the at least one memory comprises computer program codes; the at least one memory and the computer program codes are configured to be used in collaboration with the at least one processor. The second device 410 at least: transmits a first information block, the first information block used for determining a reference cell, the reference cell belonging to a first cell set, the first cell set comprising multiple cells; and determines in a first time window at least one PDCCH candidate for DCI format(s) in a target DCI format set, the target DCI format set comprising at least one DCI format for the first cell set; herein, a PDCCH candidate monitored for a DCI format in the target DCI format set is counted for PDCCH candidates monitored for the reference cell; a number of PDCCH candidates monitored for the reference cell in the first time window is no greater than a first threshold, and a number of non-overlapped CCEs for the reference cell in the first time window is no greater than a second threshold, where the first threshold is a positive integer, and the second threshold is a positive integer; a first subcarrier spacing is equal to a subcarrier spacing of at least one subcarrier occupied by the at least one PDCCH candidate monitored in the first time window for DCI format(s) in the target DCI format set in frequency domain, where the first threshold is related to the first subcarrier spacing, and the second threshold is related to the first subcarrier spacing, the first subcarrier spacing being used to determine a time length of one multicarrier symbol comprised by the first time window.

In one embodiment, the second node 410 comprises a memory that stores a computer readable instruction program, the computer readable instruction program generates actions when executed by at least one processor, which include: transmitting a first information block, the first information block used for determining a reference cell, the reference cell belonging to a first cell set, the first cell set comprising multiple cells; and determining in a first time window at least one PDCCH candidate for DCI format(s) in a target DCI format set, the target DCI format set comprising at least one DCI format for the first cell set; herein, a PDCCH candidate monitored for a DCI format in the target DCI format set is counted for PDCCH candidates monitored for the reference cell; a number of PDCCH candidates monitored for the reference cell in the first time window is no greater than a first threshold, and a number of non-overlapped CCEs for the reference cell in the first time window is no greater than a second threshold, where the first threshold is a positive integer, and the second threshold is a positive integer; a first subcarrier spacing is equal to a subcarrier spacing of at least one subcarrier occupied by the at least one PDCCH candidate monitored in the first time window for DCI format(s) in the target DCI format set in frequency domain, where the first threshold is related to the first subcarrier spacing, and the second threshold is related to the first subcarrier spacing, the first subcarrier spacing being used to determine a time length of one multicarrier symbol comprised by the first time window.

In one embodiment, the first node 450 is a UE.

In one embodiment, the second node 410 is a base station (gNB/eNB).

In one embodiment, the receiver 456 (comprising the antenna 460), the receiving processor 452 and the controller/processor 490 are used for receiving the first information block in the present application.

In one embodiment, the receiver 456 (comprising the antenna 460), the receiving processor 452 and the controller/processor 490 are used for monitoring the PDCCH candidates in the present application.

In one embodiment, the transmitter 456 (comprising the antenna 460), the transmitting processor 455 and the controller/processor 490 are used for transmitting the second information block in the present application.

In one embodiment, the transmitter 416 (comprising the antenna 420), the transmitting processor 415 and the controller/processor 440 are used for transmitting the first information block in the present application.

In one embodiment, the transmitter 416 (comprising the antenna 420), the transmitting processor 415 and the controller/processor 440 are used for determining the PDCCH candidates in the present application.

In one embodiment, the receiver 416 (comprising the antenna 420), the receiving processor 412 and the controller/processor 440 are used for receiving the second information block in the present application.

### Embodiment 5

Embodiment 5 illustrates a flowchart of radio signal transmission according to one embodiment of the present application, as shown in FIG. 5. In FIG. 5, a second node N500 is a maintenance base station for a serving cell for a first node U550. It should be particularly noted that the sequence illustrated herein does not set any limit to the signal transmission order or implementation order in the present application.

The second node N500 receives a second information block in step S501, transmits a first information block in step S502, and determines in a first time window at least one PDCCH candidate for DCI format(s) in a target DCI format set in step S503.

The first node U550 transmits a second information block in step S551, receives a first information block in step S552, and monitors in a first time window at least one PDCCH candidate for DCI format(s) in a target DCI format set in step S553.

In Embodiment 5, the first information block is used for determining a reference cell, the reference cell belonging to a first cell set, the first cell set comprising multiple cells; and the target DCI format set comprises at least one DCI format for the first cell set; a PDCCH candidate monitored for a DCI format in the target DCI format set is counted for PDCCH candidates monitored for the reference cell; a number of PDCCH candidates monitored for the reference cell in the first time window is no greater than a first threshold, and a number of non-overlapped CCEs for the reference cell in the first time window is no greater than a second threshold, where the first threshold is a positive integer, and the second threshold is a positive integer; a first subcarrier spacing is equal to a subcarrier spacing of at least one subcarrier occupied by the at least one PDCCH candidate monitored in the first time window for DCI format(s) in the target DCI format set in frequency domain, where the first threshold is related to the first subcarrier spacing, and the second threshold is related to the first subcarrier spacing, the first subcarrier spacing being used to determine a time length of one multicarrier symbol comprised by the first time window; the second information block is used for indicating a capability parameter set of a transmitter of the second information block.

In one embodiment, the second information block is transmitted via an air interface or a wireless interface.

In one embodiment, the second information block comprises all or part of a higher layer signaling or a physical layer signaling.

In one embodiment, the second information block is earlier than the first information block.

In one embodiment, the second information block is later than the first information block.

In one embodiment, the second information block comprises all or part of an RRC signaling, or the second information block comprises all or part of a MAC layer signaling.

In one embodiment, the second information block is transmitted through a PUSCH or a Physical Uplink Control Channel (PUCCH).

In one embodiment, the second information block is used to indicate capabilities of the first node in the present application.

### Embodiment 6

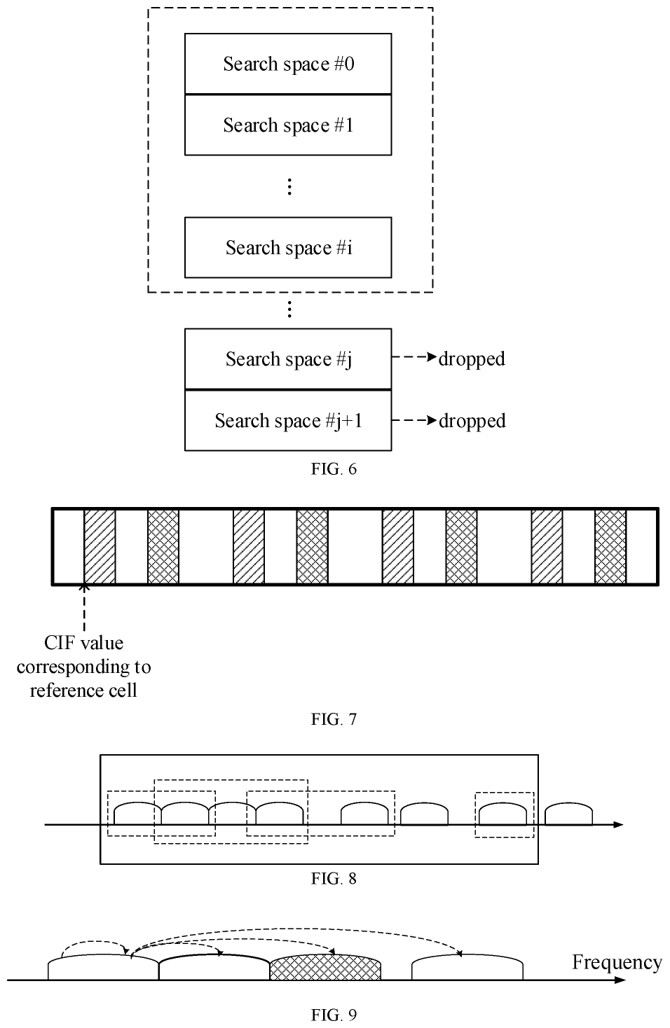

Embodiment 6 illustrates a schematic diagram of a target candidate set according to one embodiment of the present application, as shown in FIG. 6. In FIG. 6, each solid-line rectangle represents a configured search space, PDCCH candidates comprised by the search spaces in the dotted-line box belong to a target candidate set, while PDCCH candidates comprised in search spaces outside the dotted-line box are either not belonging to the target candidate set or dropped.

In Embodiment 6, a target candidate set comprises PDCCH candidate(s) monitored for the reference cell in the present application, and a first PDCCH candidate belongs to a search space configured for the reference cell, whether the first PDCCH candidate belongs to the target candidate set is related to whether the search space to which the first PDCCH candidate belongs is configured with at least one DCI format in the target DCI format set in the present application.

In one embodiment, an order in which a search space is dropped in the case of overbooking is determined according to whether the search space is used for scheduling multiple cells simultaneously, which ensures the performance of co-scheduling and thus enhances the system throughput and reduces the overhead.

In one embodiment, the reference cell is a scheduling cell of all cells in the first cell set.

In one embodiment, the reference cell is a primary cell in a cell group to which the reference cell belongs.

In one embodiment, the target candidate set comprises all PDCCH candidates monitored for the reference cell.

In one embodiment, the target candidate set comprises all PDCCH candidates actually monitored for the reference cell.

In one embodiment, the target candidate set only comprises part of PDCCH candidates configured for the reference cell.

In one embodiment, the target candidate set might only comprise part of PDCCH candidates configured for the reference cell, or might comprise all PDCCH candidates configured for the reference cell.

In one embodiment, any PDCCH candidate in the target candidate set is used for scheduling the reference cell.

In one embodiment, the target candidate set comprises a PDCCH candidate for scheduling the reference cell.

In one embodiment, any PDCCH candidate in the target candidate set is used for scheduling a signal or a channel on the reference cell.

In one embodiment, the target candidate set comprises a PDCCH candidate for scheduling a signal or a channel on the reference cell.

In one embodiment, any PDCCH candidate in the target candidate set is used for scheduling a PDSCH or a PUSCH on the reference cell.

In one embodiment, the target candidate set comprises a PDCCH candidate for scheduling a PDSCH or a PUSCH on the reference cell.

In one embodiment, the first PDCCH candidate might or might not belong to the target candidate set.

In one embodiment, a search space to which the first PDCCH candidate belongs is configured by signaling.

In one embodiment, a search space to which the first PDCCH candidate belongs is specific to the reference cell.

In one embodiment, the first PDCCH candidate is configured as scheduling the reference cell.

In one embodiment, the first PDCCH candidate is configured as scheduling a signal or channel on the reference cell.

In one embodiment, the first PDCCH candidate is any PDCCH candidate configured as scheduling the reference cell.

In one embodiment, a search space to which the first PDCCH candidate belongs configured for the reference cell is a USS.

In one embodiment, a search space to which the first PDCCH candidate belongs configured for the reference cell comprises at least one PDCCH candidate for scheduling the reference cell.

In one embodiment, a search space to which the first PDCCH candidate belongs configured for the reference cell comprises at least one PDCCH candidate for scheduling a signal or a channel on the reference cell.

In one embodiment, a search space to which the first PDCCH candidate belongs configured for the reference cell is a USS or a Type-3 common search space (CSS).

In one embodiment, a search space to which the first PDCCH candidate belongs configured for the reference cell is a USS or a CSS configured by “searchSpace” in “searchSpaceMCCH”, “searchSpaceMTCH” or “PDCCH-ConfigMulticast”.

In one embodiment, a search space to which the first PDCCH candidate belongs configured for the reference cell is a USS or a CSS using a DCI format with CRC scrambled by a G-RNTI or a G-CS-RNTI.

In one embodiment, statements that “whether the first PDCCH candidate belongs to the target candidate set” and “whether the first PDCCH candidate is monitored” have equivalent meaning or are mutually replaceable.

In one embodiment, statements that “whether the first PDCCH candidate belongs to the target candidate set” and “whether the first PDCCH candidate is reserved for overbooking” have equivalent meaning or are mutually replaceable.

In one embodiment, statements that “whether the first PDCCH candidate belongs to the target candidate set” and “whether the first PDCCH candidate is dropped” have equivalent meaning or are mutually replaceable.

In one embodiment, the technical feature that “whether the first PDCCH candidate belongs to the target candidate set is related to whether the search space to which the first PDCCH candidate belongs is configured with at least one DCI format in the target DCI format set” includes the following meaning: whether the search space to which the first PDCCH candidate belongs is configured with at least one DCI format in the target DCI format set is used to determine whether the first PDCCH candidate belongs to the target candidate set.

In one embodiment, the technical feature that “whether the first PDCCH candidate belongs to the target candidate set is related to whether the search space to which the first PDCCH candidate belongs is configured with at least one DCI format in the target DCI format set” includes the following meaning: whether the first PDCCH candidate belongs to the target candidate set is related to whether the search space to which the first PDCCH candidate belongs is configured with a DCI format scheduling multiple cells simultaneously.

In one embodiment, the technical feature that “whether the first PDCCH candidate belongs to the target candidate set is related to whether the search space to which the first PDCCH candidate belongs is configured with at least one DCI format in the target DCI format set” includes the following meaning: whether the first PDCCH candidate belongs to the target candidate set is related to whether the search space to which the first PDCCH candidate belongs is configured with the target DCI format set.

In one embodiment, the technical feature that “whether the first PDCCH candidate belongs to the target candidate set is related to whether the search space to which the first PDCCH candidate belongs is configured with at least one DCI format in the target DCI format set” includes the following meaning: whether the first PDCCH candidate belongs to the target candidate set is related to whether the search space to which the first PDCCH candidate belongs is configured with DCI formats 0_K and 1_K, where K is a positive integer greater than 2. In one subembodiment of the above embodiment, K is equal to 3, or is equal to 4, or is equal to 5.

In one embodiment, the technical feature that “whether the first PDCCH candidate belongs to the target candidate set is related to whether the search space to which the first PDCCH candidate belongs is configured with at least one DCI format in the target DCI format set” includes the following meaning: whether the first PDCCH candidate belongs to the target candidate set is related to whether the search space to which the first PDCCH candidate belongs is configured with a DCI format which can at most schedule multiple cells.

In one embodiment, the technical feature that “whether the first PDCCH candidate belongs to the target candidate set is related to whether the search space to which the first PDCCH candidate belongs is configured with at least one DCI format in the target DCI format set” includes the following meaning: there is a corresponding relationship or a conditional relationship between whether the first PDCCH candidate belongs to the target candidate set and whether the search space to which the first PDCCH candidate belongs is configured with at least one DCI format in the target DCI format set.

In one embodiment, the technical feature that “whether the first PDCCH candidate belongs to the target candidate set is related to whether the search space to which the first PDCCH candidate belongs is configured with at least one DCI format in the target DCI format set” includes the following meaning: when the search space to which the first PDCCH candidate belongs is configured with at least one DCI format in the target DCI format set, the first PDCCH candidate belongs to the target candidate set; otherwise, the first PDCCH candidate does not belong to the target candidate set.

In one embodiment, the technical feature that “whether the first PDCCH candidate belongs to the target candidate set is related to whether the search space to which the first PDCCH candidate belongs is configured with at least one DCI format in the target DCI format set” includes the following meaning: when the search space to which the first PDCCH candidate belongs is configured with a DCI format scheduling multiple cells simultaneously, the first PDCCH candidate belongs to the target candidate set; otherwise, the first PDCCH candidate does not belong to the target candidate set.

In one embodiment, the technical feature that “whether the first PDCCH candidate belongs to the target candidate set is related to whether the search space to which the first PDCCH candidate belongs is configured with at least one DCI format in the target DCI format set” includes the following meaning: when the search space to which the first PDCCH candidate belongs is configured with a DCI format scheduling multiple cells simultaneously, the first PDCCH candidate belongs to the target candidate set; otherwise, whether the first PDCCH candidate belongs to the target candidate set is related to an identity (or index) of the search space to which the first PDCCH candidate belongs.

In one embodiment, the technical feature that “whether the first PDCCH candidate belongs to the target candidate set is related to whether the search space to which the first PDCCH candidate belongs is configured with at least one DCI format in the target DCI format set” includes the following meaning: USSs configured for the reference cell are sorted in an order according to identities (or indexes) of search spaces; when the search space to which the first PDCCH candidate belongs is configured with a DCI format scheduling multiple cells simultaneously, the first PDCCH candidate belongs to the target candidate set; otherwise, PDCCH candidates comprised by the USSs configured for the reference cell are sequentially added to the target candidate set according to an order of identity (or index) of search spaces till a largest said target candidate set is obtained with the number of PDCCH candidates comprised in the target candidate set not exceeding a threshold.

In one embodiment, the technical feature that “whether the first PDCCH candidate belongs to the target candidate set is related to whether the search space to which the first PDCCH candidate belongs is configured with at least one DCI format in the target DCI format set” includes the following meaning: USSs and part of CSSs configured for the reference cell are sorted in an order according to identities (or indexes) of search spaces; when the search space to which the first PDCCH candidate belongs is configured with a DCI format scheduling multiple cells simultaneously, the first PDCCH candidate belongs to the target candidate set; otherwise, PDCCH candidates comprised by the USSs and the part of CSSs configured for the reference cell are sequentially added to the target candidate set according to an order of identity (or index) of search spaces till a largest said target candidate set is obtained with the number of PDCCH candidates comprised in the target candidate set not exceeding a threshold.

In one embodiment, the technical feature that “whether the first PDCCH candidate belongs to the target candidate set is related to whether the search space to which the first PDCCH candidate belongs is configured with at least one DCI format in the target DCI format set” includes the following meaning: USSs and part of CSSs configured for the reference cell are sorted in an order according to identities (or indexes) of search spaces; when the search space to which the first PDCCH candidate belongs is configured with a DCI format scheduling multiple cells simultaneously, the first PDCCH candidate belongs to the target candidate set; otherwise, whether the first PDCCH candidate belongs to the target candidate set is determined according to pre-defined pseudo code.

In one embodiment, whether the first PDCCH candidate belongs to the target candidate set is also related to an identity (or index) of the search space to which the first PDCCH candidate belongs.

### Embodiment 7

Embodiment 7 illustrates a schematic diagram of a CIF value corresponding to a reference cell according to one embodiment of the present application, as shown in FIG. 7. In FIG. 7, the large rectangle framed with thick solid lines represents a search space, in which each slash-filled rectangle represents a PDCCH candidate determined by a CIF value corresponding to a reference cell, and each cross-filled rectangle represents a PDCCH candidate determined by a CIF value other than the CIF value corresponding to the reference cell.

In Embodiment 7, the first information block in the present application is used to determine a first identity value, the first identity value being a non-negative number; each cell in the first cell set in the present application corresponds to one identity value, and the reference cell in the present application is a cell in the first cell set corresponding to an identity value equal to the first identity value; a Carrier Indicator Field (CIF) value corresponding to the reference cell is used to determine a CCE occupied by the at least one PDCCH candidate monitored using DCI format(s) in the target DCI format set in the present application.

In one embodiment, determining PDCCH candidates according to CIF of the reference cell reduces the blocking probability.

In one embodiment, a reference cell being indicated by a CIF value can reduce the configuration signaling overhead and ensure the backward compatibility.

In one embodiment, by associating the counting of PDCCH candidates and non-overlapped CCEs with the distribution of PDCCH candidates in the search space, the scheduling flexibility of other co-scheduling cells can be ensured to the greatest extent.

In one embodiment, the first identity value is a cell ID.

In one embodiment, the first identity value is a cell index.

In one embodiment, the first identity value is a CIF value.

In one embodiment, the first identity value is n_{CI}.

In one embodiment, the first identity value is a value configured for a cell identity other than a CIF value.

In one embodiment, the technical feature that “the first information block is used for determining a first identity value” includes the following meaning: the first information block is used by the first node in the present application to determine the first identity value.

In one embodiment, the technical feature that “the first information block is used for determining a first identity value” includes the following meaning: all or part of the first information block is used for explicitly or implicitly indicating the first identity value.

In one embodiment, an identity value corresponding to each cell in the first cell set is configured.

In one embodiment, an identity value corresponding to each cell in the first cell set is configured by an information block other than the first information block.

In one embodiment, two different signalings are used for respectively determining the first identity value and an identity value corresponding to each cell in the first cell set.

In one embodiment, two different IEs are used for respectively determining the first identity value and an identity value corresponding to each cell in the first cell set.

In one embodiment, two different fields are used for respectively determining the first identity value and

an identity value corresponding to each cell in the first cell set.

In one embodiment, an identity value corresponding to a cell in the first cell set is a default value.

In one embodiment, an identity value corresponding to each cell other than a scheduling cell in the first cell set is configured, while an identity value corresponding to the scheduling cell in the first cell set is a default value.

In one embodiment, an identity value corresponding to each cell other than a primary cell in the first cell set is configured, while an identity value corresponding to the primary cell in the first cell set is a default value.

In one embodiment, an identity value corresponding to each cell in the first cell set is a non-negative integer.

In one embodiment, an identity value corresponding to each cell other than a scheduling cell in the first cell set is a positive integer, while an identity value corresponding to the scheduling cell in the first cell set is equal to 0.

In one embodiment, an identity value corresponding to each cell other than a primary cell in the first cell set is a positive integer, while an identity value corresponding to the primary cell in the first cell set is equal to 0.

In one embodiment, an identity value corresponding to any cell in the first cell set is a CIF value of the cell.

In one embodiment, an identity value corresponding to any cell in the first cell set is an identity value other than a CIF value of the cell.

In one embodiment, an identity value corresponding to any cell in the first cell set is an ID of the cell.

In one embodiment, an identity value corresponding to any cell in the first cell set is an index of the cell.

In one embodiment, an identity value corresponding to any cell in the first cell set is a value of n_{CI} corresponding to the cell.

In one embodiment, an identity value corresponding to the reference cell is equal to the first identity value.

In one embodiment, identity values respectively corresponding to any two cells in the first cell set are unequal.

In one embodiment, the first cell set comprises two cells to which identity values respectively correspond are equal.

In one embodiment, only the reference cell in the first cell set corresponds to an identity value that is equal to the first identity value.

In one embodiment, the first cell set also comprises at least one cell other than the reference cell corresponding to identity value(s) that is(are) equal to the first identity value.

In one embodiment, a CIF value corresponding to the reference cell is configured.

In one embodiment, a CIF value corresponding to the reference cell is configured, or a CIF value corresponding to the reference cell is a default value.

In one embodiment, a CIF value corresponding to the reference cell is configured by an IE “CrossCarrierSchedulingConfig”.

In one embodiment, when the reference cell is a scheduling cell, a CIF value corresponding to the reference cell is equal to 0; when the reference cell is a cell other than a scheduling cell, a CIF value corresponding to the reference cell is configured.

In one embodiment, when the reference cell is a primary cell, the reference cell must be a scheduling cell.

In one embodiment, statements that “a CIF value corresponding to the reference cell is used to determine a CCE occupied by the at least one PDCCH candidate monitored using DCI format(s) in the target DCI format set” and “a CIF value corresponding to the reference cell is used as a CIF value corresponding to the first cell set” have equivalent meaning or are mutually replaceable.

In one embodiment, statements that “a CIF value corresponding to the reference cell is used to determine a CCE occupied by the at least one PDCCH candidate monitored using DCI format(s) in the target DCI format set” and “a CIF value corresponding to the first cell set is equal to a CIF value corresponding to the reference cell” have equivalent meaning or are mutually replaceable.

In one embodiment, statements that “a CIF value corresponding to the reference cell is used to determine a CCE occupied by the at least one PDCCH candidate monitored using DCI format(s) in the target DCI format set” and “a na value corresponding to the first cell set is equal to a CIF value corresponding to the reference cell” have equivalent meaning or are mutually replaceable.

In one embodiment, the technical feature that “a Carrier Indicator Field (CIF) value corresponding to the reference cell is used to determine a CCE occupied by the at least one PDCCH candidate monitored using DCI format(s) in the target DCI format set” includes the following meaning: a Carrier Indicator Field (CIF) value corresponding to the reference cell is used by the first node in the present application to determine a CCE occupied by the at least one PDCCH candidate monitored using DCI format(s) in the target DCI format set.

In one embodiment, the technical feature that “a Carrier Indicator Field (CIF) value corresponding to the reference cell is used to determine a CCE occupied by the at least one PDCCH candidate monitored using DCI format(s) in the target DCI format set” includes the following meaning: a Carrier Indicator Field (CIF) value corresponding to the reference cell is used to determine all CCEs occupied by the at least one PDCCH candidate monitored using DCI format(s) in the target DCI format set.

In one embodiment, the technical feature that “a Carrier Indicator Field (CIF) value corresponding to the reference cell is used to determine a CCE occupied by the at least one PDCCH candidate monitored using DCI format(s) in the target DCI format set” includes the following meaning: a Carrier Indicator Field (CIF) value corresponding to the reference cell is used to determine a starting CCE occupied by the at least one PDCCH candidate monitored using DCI format(s) in the target DCI format set.

In one embodiment, the technical feature that “a Carrier Indicator Field (CIF) value corresponding to the reference cell is used to determine a CCE occupied by the at least one PDCCH candidate monitored using DCI format(s) in the target DCI format set” includes the following meaning: a Carrier Indicator Field (CIF) value corresponding to the reference cell is used to determine CCEs occupied by the at least one PDCCH candidate scheduling multiple cells in the first cell set simultaneously.

In one embodiment, the technical feature that “a Carrier Indicator Field (CIF) value corresponding to the reference cell is used to determine a CCE occupied by the at least one PDCCH candidate monitored using DCI format(s) in the target DCI format set” includes the following meaning: a Carrier Indicator Field (CIF) value corresponding to the reference cell is used to determine a CCE occupied by the at least one PDCCH candidate monitored using DCI format(s) in the target DCI format set according to a search space formula.

In one embodiment, the technical feature that “a Carrier Indicator Field (CIF) value corresponding to the reference cell is used to determine a CCE occupied by the at least one PDCCH candidate monitored using DCI format(s) in the target DCI format set” includes the following meaning: a Carrier Indicator Field (CIF) value corresponding to the reference cell is used to calculate CCEs occupied by the at least one PDCCH candidate monitored using DCI format(s) in the target DCI format set.

In one embodiment, the technical feature that “a Carrier Indicator Field (CIF) value corresponding to the reference cell is used to determine a CCE occupied by the at least one PDCCH candidate monitored using DCI format(s) in the target DCI format set” includes the following meaning: a Carrier Indicator Field (CIF) value corresponding to the reference cell is used to determine CCEs occupied by at least one PDCCH candidate comprised by search space(s) configured with DCI format(s) scheduling multiple cells simultaneously.

In one embodiment, the technical feature that “a Carrier Indicator Field (CIF) value corresponding to the reference cell is used to determine a CCE occupied by the at least one PDCCH candidate monitored using DCI format(s) in the target DCI format set” includes the following meaning: a Carrier Indicator Field (CIF) value corresponding to the reference cell is used to determine a CCE occupied by at least one PDCCH candidate comprised by search space(s) configured with the target DCI format set.

In one embodiment, the technical feature that “a Carrier Indicator Field (CIF) value corresponding to the reference cell is used to determine a CCE occupied by the at least one PDCCH candidate monitored using DCI format(s) in the target DCI format set” is implemented by the following formula:
a search space set s that uses DCI format(s) in the target DCI format set is associated with a CORESET p, with L indicating an aggregation level, where indexes of CCEs occupied by PDCCH candidates m_{s,n}_{_{SI}}^{(L)} using L monitored using DCI format(s) in the target DCI format set satisfies:

$$L \cdot \{ ( {Y}_{p , {n}_{s , f}^{μ}} + ⌊ \frac{{m}_{s , {n}_{CI}}^{{( L )}_{c}} \cdot {N}_{CCE , p}}{L \cdot {M}_{s , max}^{( L )}} ⌋ + {n}_{CI} ) mod ⌊ {N}_{CCE , p} / L ⌋ \} + i$$

where n_{CI} indicates a CIF value corresponding to the reference cell,

$$i = 0 , ⋯ , L - 1 , {Y}_{p , {n}_{s , f}^{μ}}$$

is a value related to the CORESET p, N_{CCE,p} represents a number of CCEs in the CORESET p, and M_{s,max}^{(L)} represents a number of PDCCH candidates using aggregation level L that are configured for the search space set s.

In one embodiment, the technical feature that “a Carrier Indicator Field (CIF) value corresponding to the reference cell is used to determine a CCE occupied by the at least one PDCCH candidate monitored using DCI format(s) in the target DCI format set” is implemented by the following formula:

a search space set s configured for the reference cell that uses DCI format(s) in the target DCI format set is associated with a CORESET p, with L indicating an aggregation level, where indexes of CCEs occupied by PDCCH candidates m_{s,n}_{_{SI}}^{(L)} using L monitored using DCI format(s) in the target DCI format set satisfies:

$$L \cdot \{ ( {Y}_{p , {n}_{s , f}^{μ}} + ⌊ \frac{{m}_{s , {n}_{CI}}^{{( L )}_{c}} \cdot {N}_{CCE , p}}{L \cdot {M}_{s , max}^{( L )}} ⌋ + {n}_{CI} ) mod ⌊ {N}_{CCE , p} / L ⌋ \} + i$$

where n_{CI} indicates a CIF value corresponding to the reference cell,

$$i = 0 , ⋯ , L - 1 , {Y}_{p , {n}_{s , f}^{μ}}$$

is a value related to the CORESET p, N_{CCE,p} represents a number of CCEs in the CORESET p, and M_{s,max}^{(L)} represents a number of PDCCH candidates using aggregation level L that are configured for the search space set s configured for the reference cell.

In one embodiment, the technical feature that “a Carrier Indicator Field (CIF) value corresponding to the reference cell is used to determine a CCE occupied by the at least one PDCCH candidate monitored using DCI format(s) in the target DCI format set” is implemented by the following formula:
a search space set s configured for one cell in the first cell set that uses DCI format(s) in the target DCI format set is associated with a CORESET p, with L indicating an aggregation level, where indexes of CCEs occupied by PDCCH candidates m_{s,n}_{_{SI}}^{(L)} using L monitored using DCI format(s) in the target DCI format set satisfies:

$$L \cdot \{ ( {Y}_{p , {n}_{s , f}^{μ}} + ⌊ \frac{{m}_{s , {n}_{CI}}^{{( L )}_{c}} \cdot {N}_{CCE , p}}{L \cdot {M}_{s , max}^{( L )}} ⌋ + {n}_{CI} ) mod ⌊ {N}_{CCE , p} / L ⌋ \} + i$$

where n_{CI} indicates a CIF value corresponding to the reference cell,

$$i = 0 , ⋯ , L - 1 , {Y}_{p , {n}_{s , f}^{μ}}$$

is a value related to the CORESET p, N_{CCE,p} represents a number of CCEs in the CORESET p, and M_{s,max}^{(L)} represents a number of PDCCH candidates using aggregation level L that are configured for the search space set s.

### Embodiment 8

Embodiment 8 illustrates a schematic diagram of a first cell set according to one embodiment of the present application, as shown in FIG. 8. In FIG. 8, each curved-top area represents a cell, cells marked by each dotted-line box make up a cell subset among H cell subsets, and cells marked by the thick solid-line box make up a first cell set.

In Embodiment 8, the first cell set in the present application comprises H cell subsets, and any cell subset among the H cell subsets comprises at least one cell, and each cell comprised by any cell subset among the H cell subsets belongs to the first cell set, H being a positive integer greater than 1; size(s) of at least one DCI format in the target DCI format set in the present application is(are) related to a number of cells comprised by one cell subset with most cells among the H cell subsets.

In one embodiment, determining the size of a DCI format according to a largest number of cells in H cell subsets ensures correct reception of the DCI format.

In one embodiment, the first information block is used to determine the W cell subsets.

In one embodiment, an information block other than the first information block that belongs to a same IE as the first information block is used to determine the W cell subsets.

In one embodiment, an information block other than the first information block is used to determine the W cell subsets.

In one embodiment, the H cell subsets are determined out of the first cell set according to a predefined rule.

In one embodiment, the H cell subsets make up a cell set list.

In one embodiment, any cell comprised by any one of the H cell subsets is a cell in which a Physical Downlink Shared Channel (PDSCH) can be transmitted.

In one embodiment, any cell comprised by any one of the H cell subsets is a cell in which a Physical Uplink Shared Channel (PUSCH) can be transmitted.

In one embodiment, any cell comprised by any one of the H cell subsets is a cell in which a PDSCH or a PUSCH can be transmitted.

In one embodiment, any two cell subsets among the H cell subsets are different.

In one embodiment, there exist two cell subsets being identical among the H cell subsets.

In one embodiment, any cell subset of the H cell subsets is a set of cells that can be scheduled simultaneously by a single DCI format or a single PDCCH.

In one embodiment, any cell subset of the H cell subsets is a set of downlink cells or a set of uplink cells that can be scheduled simultaneously by a single DCI format or a single PDCCH.

In one embodiment, any cell subset of the H cell subsets is a set of cells to which PDSCHs or PUSCHs that can be scheduled simultaneously by a single DCI format or a single PDCCH respectively belong.

In one embodiment, any cell subset of the H cell subsets is a list of cells.

In one embodiment, all cells comprised by a cell subset among the H cell subsets belong to a same band.

In one embodiment, all cells comprised by a cell subset among the H cell subsets belong to a same frequency range (FR).

In one embodiment, all cells comprised by a cell subset among the H cell subsets use a same mode of Duplexing, namely, Time Division Duplexing (TDD) or Frequency Division Duplexing (FDD).

In one embodiment, a cell subset among the H cell subsets comprises two intra-band cells.

In one embodiment, a cell subset among the H cell subsets comprises two inter-band cells.

In one embodiment, all cells other than a self-scheduling cell comprised by any cell subset among the H cell subsets belong to a same band.

In one embodiment, all cells other than a self-scheduling cell comprised by any cell subset among the H cell subsets belong to a same frequency range (FR).

In one embodiment, all cells other than a self-scheduling cell comprised by any cell subset among the H cell subsets use a same mode of Duplexing, namely, TDD or FDD.

In one embodiment, any cell subset among the H cell subsets comprises multiple cells.

In one embodiment, there exists at least one cell subset comprising only one cell among the H cell subsets.

In one embodiment, any cell comprised by the first cell set belongs to at least one cell subset of the H cell subsets.

In one embodiment, a cell comprised by the first cell set does not belong to any one of the H cell subsets.

In one embodiment, the reference cell belongs to at least one cell subset among the H cell subsets.

In one embodiment, the H cell subsets consist of H1 downlink cell subset(s) and H2 uplink cell subset(s), where a sum of H1 and H2 is equal to H, H1 is a positive integer, and H2 is a positive integer.

In one embodiment, a signaling is used to determine H1 downlink cell subset(s) and H2 uplink cell subset(s), the H cell subsets consisting of H1 downlink cell subset(s) and H2 uplink cell subset(s), where a sum of H1 and H2 is equal to H, H1 is a positive integer, and H2 is a positive integer.

In one embodiment, two information blocks are used to determine H1 downlink cell subset(s) and H2 uplink cell subset(s) respectively, the H cell subsets consisting of H1 downlink cell subset(s) and H2 uplink cell subset(s), where a sum of H1 and H2 is equal to H, H1 is a positive integer, and H2 is a positive integer.

In one embodiment, a size of a DCI format is equal to a payload size of the DCI format.

In one embodiment, a size of a DCI format is equal to a number of bits comprised by the DCI format.

In one embodiment, a size of a DCI format is equal to a number of payload bits comprised by the DCI format.

In one embodiment, a size of a DCI format is equal to a total number of payload bits and CRC bits comprised by the DCI format.

In one embodiment, a size of a DCI format is equal to a number of information bits comprised by the DCI format.

In one embodiment, a size of a DCI format is equal to a total number of information bits and CRC bits comprised by the DCI format.

In one embodiment, a size of a DCI format is equal to a size of the DCI format without being through size alignment.

In one embodiment, a size of a DCI format is equal to a size of the DCI format before being through size alignment.

In one embodiment, a size of a DCI format is equal to a size of the DCI format without being through padding or truncation.

In one embodiment, a size of a DCI format is equal to a size obtained by the DCI format through size alignment.

In one embodiment, a size of a DCI format is equal to a size obtained by the DCI format being through size alignment of uplink and downlink scheduling DCI formats.

In one embodiment, a size of a DCI format is equal to a size of the DCI format after being through padding or truncation.

In one embodiment, a size of a DCI format is a size assumed for monitoring a PDCCH candidate for the DCI format.

In one embodiment, a size of a DCI format is a size assumed for decoding a PDCCH assumed to be carrying the DCI format.

In one embodiment, the technical feature that “size(s) of at least one DCI format in the target DCI format set is(are) related to a number of cells comprised by one cell subset with most cells among the H cell subsets” includes the following meaning: size(s) of DCI format(s) in the target DCI format set capable of scheduling multiple cells simultaneously is(are) related to a number of cells comprised by one cell subset with most cells among the H cell subsets.

In one embodiment, the technical feature that “size(s) of at least one DCI format in the target DCI format set is(are) related to a number of cells comprised by one cell subset with most cells among the H cell subsets” includes the following meaning: a number of cells comprised by one cell subset with most cells among the H cell subsets is used to determine size(s) of at least one DCI format in the target DCI format set.

In one embodiment, the technical feature that “size(s) of at least one DCI format in the target DCI format set is(are) related to a number of cells comprised by one cell subset with most cells among the H cell subsets” includes the following meaning: a number of bits comprised by at least one field comprised by at least one DCI format in the target DCI format set is related to a number of cells comprised by one cell subset with most cells among the H cell subsets.

In one embodiment, the technical feature that “size(s) of at least one DCI format in the target DCI format set is(are) related to a number of cells comprised by one cell subset with most cells among the H cell subsets” includes the following meaning: at least one of a number of bits comprised by at least one field comprised by at least one DCI format in the target DCI format set or a number of fields of a same type comprised by at least one DCI format in the target DCI format set is related to a number of cells comprised by one cell subset with most cells among the H cell subsets.

In one embodiment, the technical feature that “size(s) of at least one DCI format in the target DCI format set is(are) related to a number of cells comprised by one cell subset with most cells among the H cell subsets” includes the following meaning: bit width(s) of at least one field comprised by at least one DCI format in the target DCI format set is(are) related to a number of cells comprised by one cell subset with most cells among the H cell subsets.

In one embodiment, the technical feature that “size(s) of at least one DCI format in the target DCI format set is(are) related to a number of cells comprised by one cell subset with most cells among the H cell subsets” includes the following meaning: at least one of a number of bits comprised by at least one field comprised by at least one DCI format in the target DCI format set or a number of fields comprised by at least one DCI format in the target DCI format set is linear with a number of cells comprised by one cell subset with most cells among the H cell subsets.

In one embodiment, the technical feature that “size(s) of at least one DCI format in the target DCI format set is(are) related to a number of cells comprised by one cell subset with most cells among the H cell subsets” includes the following meaning: a number of cells comprised by one cell subset with most cells among the H cell subsets is used for calculating at least one of a number of bits comprised by at least one field comprised by at least one DCI format in the target DCI format set or a number of fields comprised by at least one DCI format in the target DCI format set.

In one embodiment, the technical feature that “size(s) of at least one DCI format in the target DCI format set is(are) related to a number of cells comprised by one cell subset with most cells among the H cell subsets” includes the following meaning: a number of bits comprised by at least one field comprised by at least one DCI format in the target DCI format set is linear with a value obtained by a logarithm of a number of cells comprised by one cell subset with most cells among the H cell subsets to the base 2 being rounded up to a nearest integer.

In one embodiment, the technical feature that “size(s) of at least one DCI format in the target DCI format set is(are) related to a number of cells comprised by one cell subset with most cells among the H cell subsets” includes the following meaning: a number of bits comprised by at least one field comprised by at least one DCI format in the target DCI format set is linear with a value obtained by a logarithm of a number of cells comprised by one cell subset with most cells among the H cell subsets to the base 2 being rounded up to a nearest integer, and a number of fields comprised by at least one DCI format in the target DCI format set is linear with a number of cells comprised by one cell subset with most cells among the H cell subsets.

In one embodiment, the technical feature that “size(s) of at least one DCI format in the target DCI format set is(are) related to a number of cells comprised by one cell subset with most cells among the H cell subsets” includes the following meaning: the H cell subsets comprise H1 cell subset(s) and H2 cell subset(s), any cell subset of the H1 cell subset(s) being one of the H cell subsets, and any cell subset of the H2 cell subset(s) being one of the H cell subsets, where H1 is a positive integer, and H2 is a positive integer, and a sum of H1 and H2 is no greater than H; a first quantity value is equal to a number of cells comprised by one cell subset with most cells among the H1 cell subset(s), while a second quantity value is equal to a number of cells comprised by one cell subset with most cells among the H2 cell subset(s), where the first quantity value is used to determine a first candidate size, while the second quantity value is used to determine a second candidate size, and size(s) of at least one DCI format in the target DCI format set is(are) equal to a maximum value between the first candidate size and the second candidate size. In one subsidiary embodiment of the above embodiment, the H1 cell subset(s) and the H2 cell subset(s) are respectively configured by two signalings. In one subsidiary embodiment of the above embodiment, the H1 cell subset(s) and the H2 cell subset(s) are respectively configured by two different IEs or fields in a same signaling. In one subsidiary embodiment of the above embodiment, the H cell subsets are made up of the H1 cell subset(s) and the H2 cell subset(s). In one subsidiary embodiment of the above embodiment, any cell comprised by any of the H1 cell subset(s) is a downlink cell, while any cell comprised by any of the H2 cell subset(s) is an uplink cell. In one subsidiary embodiment of the above embodiment, any cell comprised by any of the H1 cell subset(s) is a cell that can transmit a PDSCH, while any cell comprised by any of the H2 cell subset(s) is a cell that can transmit a PUSCH.

In one embodiment, the technical feature that “size(s) of at least one DCI format in the target DCI format set is(are) related to a number of cells comprised by one cell subset with most cells among the H cell subsets” includes the following meaning: the H cell subsets are divided into H1 cell subset(s) and H2 cell subset(s), any cell subset of the H1 cell subset(s) being one of the H cell subsets, and any cell subset of the H2 cell subset(s) being one of the H cell subsets, where H1 is a positive integer, and H2 is a positive integer, and a sum of H1 and H2 is equal to H; a first quantity value is equal to a number of cells comprised by one cell subset with most cells among the H1 cell subset(s), while a second quantity value is equal to a number of cells comprised by one cell subset with most cells among the H2 cell subset(s), where the first quantity value is used to determine a first candidate size, while the second quantity value is used to determine a second candidate size, and size(s) of at least one DCI format in the target DCI format set is(are) equal to a maximum value between the first candidate size and the second candidate size. In one subsidiary embodiment of the above embodiment, the H1 cell subset(s) and the H2 cell subset(s) are respectively configured by two signalings. In one subsidiary embodiment of the above embodiment, the H1 cell subset(s) and the H2 cell subset(s) are respectively configured by two different IEs or fields in a same signaling. In one subsidiary embodiment of the above embodiment, the H cell subsets are made up of the H1 cell subset(s) and the H2 cell subset(s). In one subsidiary embodiment of the above embodiment, any cell comprised by any of the H1 cell subset(s) is a downlink cell, while any cell comprised by any of the H2 cell subset(s) is an uplink cell. In one subsidiary embodiment of the above embodiment, any cell comprised by any of the H1 cell subset(s) is a cell that can transmit a PDSCH, while any cell comprised by any of the H2 cell subset(s) is a cell that can transmit a PUSCH.

In one embodiment, the technical feature that “size(s) of at least one DCI format in the target DCI format set is(are) related to a number of cells comprised by one cell subset with most cells among the H cell subsets” includes the following meaning: size(s) of at least one DCI format in the target DCI format set is(are) equal to a larger value between a first candidate size and a second candidate size, where a number of cells comprised by one cell subset with most cells among the H cell subsets is used to determine one of a first candidate size or a second candidate size.

In one embodiment, a number of bits comprised by one field comprised by 1 DCI format is equal to a bit width of the field.

In one embodiment, at least one of a number of bits comprised by a New Data Indicator (NDI) field, a number of bits comprised by a HARQ process number field or a number of bits comprised by a Modulation and coding scheme (MCS) field comprised by each size of at least one DCI format in the target DCI format set is related to a number of cells comprised by one cell subset with most cells among the H cell subsets.

In one embodiment, number(s) of bits comprised by at least one of a Frequency domain resource assignment field, an antenna port field, or a transmission configuration indication (TCI) field comprised by size(s) of at least one DCI format in the target DCI format set is(are) related to a number of cells comprised by one cell subset with most cells among the H cell subsets.

In one embodiment, a total number of fields comprised by size(s) of at least one DCI format in the target DCI format set is related to a number of cells comprised by one cell subset with most cells among the H cell subsets.

In one embodiment, a total number of fields comprised by size(s) of at least one DCI format in the target DCI format set is linear with a number of cells comprised by one cell subset with most cells among the H cell subsets.

In one embodiment, a total number of fields of a same type comprised by size(s) of at least one DCI format in the target DCI format set is related to a number of cells comprised by one cell subset with most cells among the H cell subsets, where the same type refers to one of or a combination of multiple of NDI, HARQ process number, RV, MCS, frequency domain resource assignment, time domain resource assignment, PUCCH resource indication, PDSCH to HARQ feedback timing indication, antenna port or TCI.

In one embodiment, there exist several cell subsets that suit a nested structure among the H cell subsets.

### Embodiment 9

Embodiment 9 illustrates a schematic diagram of a reference cell according to an embodiment of the present application, as shown in FIG. 9. In FIG. 9, each curved-top area represents a cell, with a dotted-line arrowhead indicating the scheduling and scheduled relationship between cells, and the curved-top area filled with cross lines represents a reference cell.

In Embodiment 9, the reference cell in the present application is a cell in the first cell set configured with a search space that uses one or more DCI formats only in a reference DCI format set and comprises a smallest total number of PDCCH candidates, where the reference DCI format set is pre-defined or configurable.

In one embodiment, PDCCH candidates and non-overlapped CCEs are counted for a cell with a smallest number of single-cell scheduled PDCCH candidates, which can avoid the influence on other co-scheduling cells, thus increasing the scheduling flexibility.

In one embodiment, the phrase that “the reference DCI format set is pre-defined” includes the following meaning: the reference DCI format set comprises DCI formats 0_0, 0_1, 0_2, 1_0, 1_1, and 1_2.

In one embodiment, the phrase that “the reference DCI format set is pre-defined” includes the following meaning: the reference DCI format set comprises DCI formats 0_0, 0_1, 1_0 and 1_1.

In one embodiment, the phrase that “the reference DCI format set is pre-defined” includes the following meaning: the reference DCI format set comprises DCI formats 0_1, 0_2, 1_1, and 1_2.

In one embodiment, the phrase that “the reference DCI format set is pre-defined” includes the following meaning: the reference DCI format set comprises DCI formats 0_0 and 1_0.

In one embodiment, the phrase that “the reference DCI format set is pre-defined” includes the following meaning: the reference DCI format set comprises multiple formats among DCI formats 0_0, 0_1, 0_2, 1_0, 1_1, 1_2, 2_0, 2_1, 2_2, 2_3, 2_4, 2_5, 2_6, 2_7, 3_0, 3_1, 4_0, 4_1, and 4_2.

In one embodiment, the phrase that “the reference DCI format set is pre-defined” includes the following meaning: the reference DCI format set can be a set of multiple formats predefined among DCI formats 0_0, 0_1, 0_2, 1_0, 1_1, 1_2, 2_0, 2_1, 2_2, 2_3, 2_4, 2_5, 2_6, 2_7, 3_0, 3_1, 4_0, 4_1, and 4_2.

In one embodiment, the phrase that “the reference DCI format set is pre-defined” includes the following meaning: the reference DCI format set is a set consisting of DCI formats other than DCI format 0_K or DCI format 1_K, where K is a positive integer greater than 2. In one subembodiment of the above embodiment, K is equal to 3, or is equal to 4, or is equal to 5.

In one embodiment, the phrase that “the reference DCI format set is pre-defined” includes the following meaning: the reference DCI format set is a set consisting of DCI formats other than a DCI format that can be used for scheduling multiple cells simultaneously.

In one embodiment, the phrase that “the reference DCI format set is pre-defined” includes the following meaning: the reference DCI format set is a set consisting of DCI formats other than a unicast DCI format that can be used for scheduling multiple cells simultaneously.

In one embodiment, the phrase that “the reference DCI format set is pre-defined” includes the following meaning: the reference DCI format set is a set consisting of DCI formats other than a DCI format that can be used for scheduling multiple cells simultaneously and is either non-groupcast or broadcast.

In one embodiment, the phrase that “the reference DCI format set is pre-defined” includes the following meaning: the reference DCI format set is a set consisting of DCI formats other than a DCI format that can be used for simultaneously scheduling multiple PDSCHs or PUSCHs respectively on multiple cells.

In one embodiment, the phrase that “the reference DCI format set is pre-defined” includes the following meaning: the reference DCI format set is a set consisting of DCI formats other than a DCI format that can be used for simultaneously scheduling multiple different PDSCHs or PUSCHs respectively on multiple cells.

In one embodiment, the phrase that “the reference DCI format set is pre-defined” includes the following meaning: the reference DCI format set is a set consisting of DCI formats other than a DCI format that can be used for simultaneously scheduling multiple different Transport Blocks (TBs) respectively on multiple cells.

In one embodiment, the phrase that “the reference DCI format set is configurable” includes the following meaning: the reference DCI format set is explicitly or implicitly indicated by signaling.

In one embodiment, the phrase that “the reference DCI format set is configurable” includes the following meaning: DCI formats comprised by the reference DCI format set are explicitly or implicitly indicated by signaling.

In one embodiment, statements that “a search space that only uses one or more than one DCI format in a reference DCI format set” and “a search space that is only configured with one or more than one DCI format in the reference DCI format set” have equivalent meaning or are mutually replaceable.

In one embodiment, statements that “a search space that only uses one or more than one DCI format in a reference DCI format set” and “a search space that is only configured with a DCI format only capable of scheduling one cell” have equivalent meaning or are mutually replaceable.

In one embodiment, statements that “a search space that only uses one or more than one DCI format in a reference DCI format set” and “a search space that is only configured with a DCI format other than a DCI format capable of scheduling multiple cells simultaneously” have equivalent meaning or are mutually replaceable.

In one embodiment, statements that “a search space that only uses one or more than one DCI format in a reference DCI format set” and “a search space not configured with a DCI format capable of scheduling multiple cells simultaneously” have equivalent meaning or are mutually replaceable.

In one embodiment, statements that “a search space that only uses one or more than one DCI format in a reference DCI format set” and “a search space that is only configured with a DCI format other than the reference DCI format set” have equivalent meaning or are mutually replaceable.

In one embodiment, statements that “scheduling multiple cells simultaneously” and “simultaneously scheduling PDSCHs or PUSCHs respectively on multiple cells” have equivalent meaning or are mutually replaceable.

In one embodiment, the technical feature that “the reference cell is a cell in the first cell set configured with a search space that uses one or more DCI formats only in a reference DCI format set and comprises a smallest total number of PDCCH candidates” includes the following meaning: a total number of PDCCH candidates comprised by a search space that only uses one or more than one DCI format in a reference DCI format set with which any cell other than the reference cell in the first cell set is configured is no less than the reference cell.

In one embodiment, the technical feature that “the reference cell is a cell in the first cell set configured with a search space that uses one or more DCI formats only in a reference DCI format set and comprises a smallest total number of PDCCH candidates” includes the following meaning: a total number of PDCCH candidates comprised by a search space that does not support any DCI format in simultaneously scheduling multiple cells with which any cell other than the reference cell in the first cell set is configured is no less than the reference cell.

In one embodiment, the technical feature that “the reference cell is a cell in the first cell set configured with a search space that uses one or more DCI formats only in a reference DCI format set and comprises a smallest total number of PDCCH candidates” includes the following meaning: any cell in the first cell set is configured with a positive integer number of search space(s) that only uses/use one or more than one DCI format in the reference DCI format set, where the reference cell is a cell in the first cell set configured with the positive integer number of search space(s) with a smallest total number of PDCCH candidates being comprised.

In one embodiment, the technical feature that “the reference cell is a cell in the first cell set configured with a search space that uses one or more DCI formats only in a reference DCI format set and comprises a smallest total number of PDCCH candidates” includes the following meaning: the first cell set comprises P1 cells, and the P1 cells are respectively configured with P1 search space lists, among which any search space list comprises at least one search space, P1 being a positive integer greater than 1; P1 quantity values are respectively total numbers of PDCCH candidates respectively comprised by search spaces in the P1 search space lists that only use one or more than one DCI format in the reference DCI format set, where the reference cell is a cell corresponding to a smallest one of the P1 quantity values.

In one embodiment, the technical feature that “the reference cell is a cell in the first cell set configured with a search space that uses one or more DCI formats only in a reference DCI format set and comprises a smallest total number of PDCCH candidates” includes the following meaning: the first cell set comprises P1 cells, the P1 cells respectively corresponding to P1 quantity values, and the P1 cells being respectively configured with P1 search space lists, among which any search space list comprises at least one search space, P1 being a positive integer greater than 1; any of the P1 quantity values is equal to a total number of PDCCH candidates comprised by all search spaces that only use one or more than one DCI format in the reference DCI format set in a search space list corresponding to the quantity value, where the reference cell is a cell corresponding to a smallest one of the P1 quantity values.

In one embodiment, the technical feature that “the reference cell is a cell in the first cell set configured with a search space that uses one or more DCI formats only in a reference DCI format set and comprises a smallest total number of PDCCH candidates” includes the following meaning: the reference cell is a cell in the first cell set configured with all search spaces without being configured with any DCI format capable of scheduling multiple cells simultaneously that comprise a smallest total number of PDCCH candidates.

In one embodiment, the technical feature that “the reference cell is a cell in the first cell set configured with a search space that uses one or more DCI formats only in a reference DCI format set and comprises a smallest total number of PDCCH candidates” includes the following meaning: the reference cell is a cell in the first cell set configured with all USSs without being configured with any DCI format capable of scheduling multiple cells simultaneously that comprise a smallest total number of PDCCH candidates.

In one embodiment, the technical feature that “the reference cell is a cell in the first cell set configured with a search space that uses one or more DCI formats only in a reference DCI format set and comprises a smallest total number of PDCCH candidates” includes the following meaning: the reference cell is a cell in the first cell set configured with a USS that only uses one or more than one DCI format in a reference DCI format set comprising a smallest total number of PDCCH candidates.

In one embodiment, the technical feature that “the reference cell is a cell in the first cell set configured with a search space that uses one or more DCI formats only in a reference DCI format set and comprises a smallest total number of PDCCH candidates” includes the following meaning: the reference cell is a cell in the first cell set configured with all USSs and broadcast/groupcast CSSs without being configured with any DCI format capable of scheduling multiple cells simultaneously that comprise a smallest total number of PDCCH candidates.

In one embodiment, the technical feature that “the reference cell is a cell in the first cell set configured with a search space that uses one or more DCI formats only in a reference DCI format set and comprises a smallest total number of PDCCH candidates” includes the following meaning: the reference cell is a cell in the first cell set configured with a USS and a broadcast/groupcast CSS that only use one or more than one DCI format in a reference DCI format set comprising a smallest total number of PDCCH candidates.

In one embodiment, when there are multiple cells being configured with search spaces that only use one or more than one DCI format in a reference DCI format set by which the total numbers of PDCCH candidates comprised respectively are equal to the reference cell, the reference cell is a cell with a smallest or largest cell identity (or index or CIF value) among the multiple cells.

In one embodiment, the technical feature that “the reference cell is a cell in the first cell set configured with a search space that uses one or more DCI formats only in a reference DCI format set and comprises a smallest total number of PDCCH candidates” includes the following meaning: the reference cell is a Secondary Cell (Scell) in the first cell set configured with a search space that only uses one or more than one DCI format in a reference DCI format set comprising a smallest total number of PDCCH candidates.

In one embodiment, the technical feature that “the reference cell is a cell in the first cell set configured with a search space that uses one or more DCI formats only in a reference DCI format set and comprises a smallest total number of PDCCH candidates” includes the following meaning: the reference cell is a non-scheduling cell in the first cell set configured with a search space that only uses one or more than one DCI format in a reference DCI format set comprising a smallest total number of PDCCH candidates.

### Embodiment 10

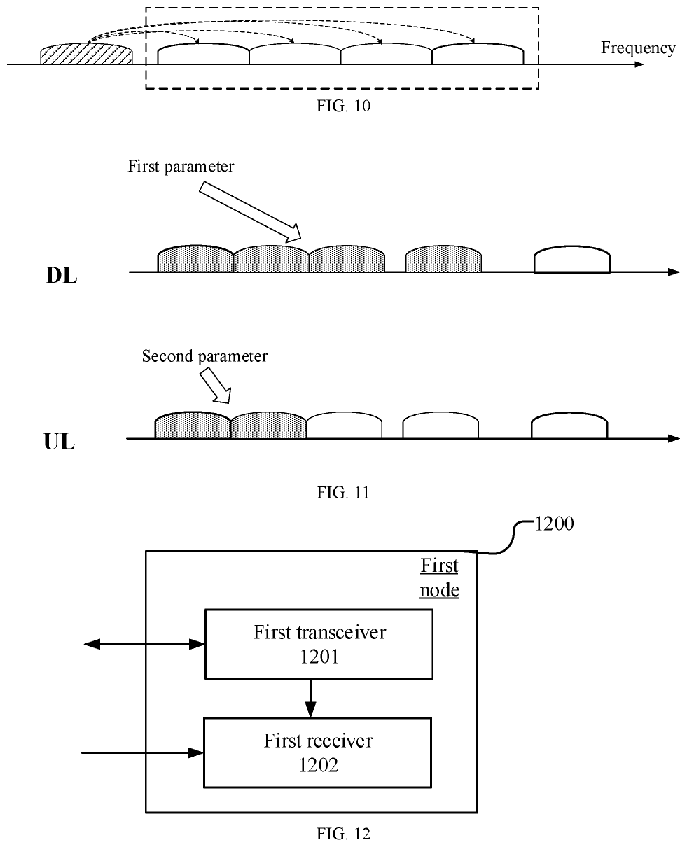

Embodiment 10 illustrates a schematic diagram of a first scheduling cell according to one embodiment of the present application, as shown in FIG. 10. In FIG. 10, each curved-top area represents a cell, with a dotted-line arrowhead indicating the scheduling and scheduled relationship between cells, and the curved-top area filled with oblique lines represents a first scheduling cell, and each cell in the dotted-line box belongs to a first cell set.

In Embodiment 10, a first scheduling cell is a scheduling cell for the first cell set in the present application, and the first scheduling cell is configured with a first search space, a reference identity value being equal to an identity value of the first search space; a characteristic quantity value is equal to a number of PDCCH candidate(s) using a first Aggregation Level (AL) for the first cell set comprised by the first search space, where the first AL is a positive integer; a number of PDCCH candidate(s) using the first AL configured for a search space for any cell in the first cell set and with an identity value equal to the reference identity value is used to determine the characteristic quantity value.

In one embodiment, there are no restrictions on cells configured with co-scheduling search spaces, which improves the configuration flexibility, so that the network can be optimized on demand to improve the system performance.

In one embodiment, the first cell set only comprises one cell being configured with a search space with an identity value equal to the reference identity value.

In one embodiment, the first node expects or assumes that the first cell set only comprises one cell being configured with a search space with an identity value equal to the reference identity value.

In one embodiment, the first node does not expect that the first cell set comprises multiple cells of which each is configured with a search space with an identity value equal to the reference identity value.

In one embodiment, the first node cannot assume that the first cell set comprises multiple cells of which each is configured with a search space with an identity value equal to the reference identity value.

In one embodiment, when the first cell set comprises multiple cells of which each is configured with a search space with an identity value equal to the reference identity value, numbers of PDCCH candidates using the first AL respectively configured for the search spaces with the identity value equal to the reference identity value configured for the multiple cells are mutually equal.

In one embodiment, when the first cell set comprises multiple cells of which each is configured with a search space with an identity value equal to the reference identity value, numbers of PDCCH candidates using a same AL respectively configured for the search spaces with the identity value equal to the reference identity value configured for the multiple cells are mutually equal.

In one embodiment, when the first cell set comprises multiple cells of which each is configured with a search space with an identity value equal to the reference identity value, the first node expects (or assumes) that numbers of PDCCH candidates using the first AL respectively configured for the search spaces with the identity value equal to the reference identity value configured for the multiple cells are mutually equal.

In one embodiment, when the first cell set comprises multiple cells of which each is configured with a search space with an identity value equal to the reference identity value, the first node expects (or assumes) that numbers of PDCCH candidates using a same AL respectively configured for the search spaces with the identity value equal to the reference identity value configured for the multiple cells are mutually equal.

In one embodiment, the technical feature that “a first scheduling cell is a scheduling cell for the first cell set” includes the following meaning: the first scheduling cell is a scheduling cell for each cell in the first cell set.

In one embodiment, the technical feature that “a first scheduling cell is a scheduling cell for the first cell set” includes the following meaning: the first scheduling cell is a scheduling cell for partial cell(s) in the first cell set.

In one embodiment, the technical feature that “a first scheduling cell is a scheduling cell for the first cell set” includes the following meaning: the first scheduling cell is a scheduling cell for multiple cells in the first cell set.

In one embodiment, the technical feature that “a first scheduling cell is a scheduling cell for the first cell set” includes the following meaning: a PDCCH on the first scheduling cell is used for scheduling all or partial cells in the first cell set.

In one embodiment, the technical feature that “a first scheduling cell is a scheduling cell for the first cell set” includes the following meaning: a PDCCH on the first scheduling cell is used for scheduling signals or channels on all or partial cells in the first cell set.

In one embodiment, the technical feature that “a first scheduling cell is a scheduling cell for the first cell set” includes the following meaning: the first scheduling cell signals downlink allocation or uplink grant to all or partial cells in the first cell set.

In one embodiment, the first information block is used for explicitly or implicitly indicating that the first scheduling cell is a scheduling cell of the first cell set.

In one embodiment, a signaling other than the first information block is used for explicitly or implicitly indicating that the first scheduling cell is a scheduling cell of the first cell set.

In one embodiment, only part of PDCCH candidates in the first search space are monitored.

In one embodiment, all of PDCCH candidates in the first search space are monitored.

In one embodiment, the first search space is a USS.

In one embodiment, the first search space is a USS configured with a DCI format capable of scheduling multiple PDSCH-comprising cells or multiple PUSCH-comprising cells.

In one embodiment, the first search space is a USS dedicated to a single DCI or PDCCH scheduling multiple cells simultaneously.

In one embodiment, the first search space is a USS that both supports a single DCI or PDCCH scheduling only one cell and supports a single DCI or PDCCH scheduling multiple cells simultaneously.

In one embodiment, the first search space is a search space set configured by a search space configuration.

In one embodiment, the first search space is a search space in a PDCCH configuration.

In one embodiment, an index value of the first search space set is equal to 0.

In one embodiment, an index value of the first search space set is greater than 0.

In one embodiment, the technical feature that “the first scheduling cell is configured with a first search space” includes the following meaning: the first search space is configured for the first scheduling cell.

In one embodiment, the technical feature that “the first scheduling cell is configured with a first search space” includes the following meaning: the first search space is specific to the first scheduling cell.

In one embodiment, the technical feature that “the first scheduling cell is configured with a first search space” includes the following meaning: the first search space is configured in a PDCCH configuration signaling (or IE) for the first scheduling cell.

In one embodiment, the technical feature that “the first scheduling cell is configured with a first search space” includes the following meaning: the first search space is configured in a configuration signaling (or IE) that configures a BWP on the first scheduling cell.

In one embodiment, the technical feature that “the first scheduling cell is configured with a first search space” includes the following meaning: the first search space is configured in a PDCCH configuration signaling (or IE) used for the first scheduling cell.

In one embodiment, statements that “the first search space comprises at least one PDCCH candidate for the first cell set” and “the first search space set is configured with the target DCI format set” have equivalent meaning or are mutually replaceable.

In one embodiment, statements that “the first search space comprises at least one PDCCH candidate for the first cell set” and “the first search space is a search space configured with the target DCI format set” have equivalent meaning or are mutually replaceable.

In one embodiment, statements that “the first search space comprises at least one PDCCH candidate for the first cell set” and “the first search space comprises at least one PDCCH candidate used for scheduling multiple cells in the first cell set simultaneously” have equivalent meaning or are mutually replaceable.

In one embodiment, statements that “the first search space comprises at least one PDCCH candidate for the first cell set” and “the first search space is configured with a DCI format capable of scheduling multiple cells in the first cell set simultaneously” have equivalent meaning or are mutually replaceable.

In one embodiment, statements that “the first search space comprises at least one PDCCH candidate for the first cell set” and “the first search space comprises at least one PDCCH candidate monitored using a DCI format in the target DCI format set” have equivalent meaning or are mutually replaceable.

In one embodiment, the reference identity value is a non-negative integer.

In one embodiment, the reference identity value is a positive integer.

In one embodiment, the reference identity value is an ID of the first search space.

In one embodiment, the reference identity value is an index of the first search space.

In one embodiment, the reference identity value is a configured or default value.

In one embodiment, the first Aggregation Level (AL) is equal to one of 1, 2, 4, 8 or 16.

In one embodiment, the first AL is an Aggregation Level (AL) supported by (or configured for) the first search space.

In one embodiment, the first AL is equal to an Aggregation Level (AL) supported by (or configured for) at least one search space in at least one cell in the first cell set.

In one embodiment, an aggregation level used by a PDCCH candidate is a number of Control Channel Elements (CCEs) occupied by (or mapped to) the PDCCH candidate.

In one embodiment, a number of CCEs occupied by any PDCCH candidate that uses the first AL is equal to the first AL.

In one embodiment, all or part of the first information block is used for explicitly or implicitly indicating the first Aggregation Level (AL).

In one embodiment, all or part of a signaling other than the first information block is used for explicitly or implicitly indicating the first Aggregation Level (AL).

In one embodiment, the first AL can be any configured aggregation level.

In one embodiment, a PDCCH candidate for the first cell set is a PDCCH candidate used for scheduling all or part of cells in the first cell set simultaneously.

In one embodiment, a PDCCH candidate for the first cell set is a PDCCH candidate used for scheduling multiple cells in the first cell set simultaneously.

In one embodiment, a PDCCH candidate for the first cell set is a PDCCH candidate determined according to an identity or index of the first cell set.

In one embodiment, a PDCCH candidate for the first cell set is a PDCCH candidate determined according to a CIF value (or a n_{CI} value) corresponding to the first cell set.

In one embodiment, a PDCCH candidate for the first cell set is a PDCCH candidate determined according to a CIF value (or a n_{CI} value) corresponding to the first cell set.

In one embodiment, a PDCCH candidate for the first cell set is a PDCCH candidate determined according to a CIF value (or a n_{CI} value) corresponding to the reference cell.

In one embodiment, a PDCCH candidate for the first cell set is a PDCCH candidate monitored using a DCI format in the target DCI format set.

In one embodiment, a PDCCH candidate for the first cell set is a PDCCH candidate monitored using a DCI format capable of scheduling multiple cells in the first cell set simultaneously.

In one embodiment, a PDCCH candidate for the first cell set is a PDCCH candidate that simultaneously schedules all cells comprised by one of the H cell subsets in the present application.

In one embodiment, the characteristic quantity value is a non-negative integer.

In one embodiment, the characteristic quantity value is a positive integer.

In one embodiment, the characteristic quantity value is a value of M_{s,n}_{_{CI}}^{(L)}, where s represents the reference identity value, L represents the first AL, and n_{CI} represents an identity or index of the first cell set.

In one embodiment, the characteristic quantity value is a value of M_{s,n}_{_{CI}}^{(L)}, where s represents the reference identity value, L represents the first AL, and n_{CI} represents a CIF value corresponding to the first cell set.

In one embodiment, the characteristic quantity value is a value of M_{s,n}_{_{CI}}^{(L)}, where s represents the reference identity value, L represents the first AL, and n_{CI} represents a CIF value corresponding to the reference cell.

In one embodiment, the characteristic quantity value is a value of M_{s,n}_{_{CI}}^{(L)}, where s represents the reference identity value, L represents the first AL, and n_{CI} represents an index value or identity value of a cell subset of the H cell subsets in the present application.

In one embodiment, the technical feature that “a number of PDCCH candidate(s) using the first AL configured for a search space for any cell in the first cell set and with an identity value equal to the reference identity value is used to determine the characteristic quantity value” includes the following meaning: the characteristic quantity value is equal to a number of PDCCH candidate(s) using the first AL configured for a search space for any cell in the first cell set and with an identity value equal to the reference identity value.

In one embodiment, the technical feature that “a number of PDCCH candidate(s) using the first AL configured for a search space for any cell in the first cell set and with an identity value equal to the reference identity value is used to determine the characteristic quantity value” includes the following meaning: a number of PDCCH candidate(s) using the first AL configured for a search space for any cell in the first cell set and with an identity value equal to the reference identity value is used by the first node in the present application to determine the characteristic quantity value.

In one embodiment, the technical feature that “a number of PDCCH candidate(s) using the first AL configured for a search space for any cell in the first cell set and with an identity value equal to the reference identity value is used to determine the characteristic quantity value” includes the following meaning: a number of PDCCH candidate(s) using the first AL configured for a search space for any cell in the first cell set and with an identity value equal to the reference identity value is used to calculate the characteristic quantity value.

In one embodiment, the technical feature that “a number of PDCCH candidate(s) using the first AL configured for a search space for any cell in the first cell set and with an identity value equal to the reference identity value is used to determine the characteristic quantity value” includes the following meaning: the characteristic quantity value is linear with a number of PDCCH candidate(s) using the first AL configured for a search space for any cell in the first cell set and with an identity value equal to the reference identity value.

In one embodiment, the technical feature that “a number of PDCCH candidate(s) using the first AL configured for a search space for any cell in the first cell set and with an identity value equal to the reference identity value is used to determine the characteristic quantity value” includes the following meaning: the characteristic quantity value is equal to a smaller one between a number of PDCCH candidate(s) using the first AL configured for a search space for any cell in the first cell set and with an identity value equal to the reference identity value and a threshold.

In one embodiment, the technical feature that “a number of PDCCH candidate(s) using the first AL configured for a search space for any cell in the first cell set and with an identity value equal to the reference identity value is used to determine the characteristic quantity value” includes the following meaning: a cell in the first cell set configured with a search space with an identity value equal to the reference identity value can be any cell in the first cell set.

In one embodiment, the technical feature that “a number of PDCCH candidate(s) using the first AL configured for a search space for any cell in the first cell set and with an identity value equal to the reference identity value is used to determine the characteristic quantity value” includes the following meaning: a cell in the first cell set configured with a search space with an identity value equal to the reference identity value is implementation-specific and not bound by the protocol.

In one embodiment, the technical feature that “a number of PDCCH candidate(s) using the first AL configured for a search space for any cell in the first cell set and with an identity value equal to the reference identity value is used to determine the characteristic quantity value” includes the following meaning: search space(s) that the first scheduling cell is configured with is(are) associated with search space(s) that at least one cell in the first cell set is configured with according to search space identity(identities).

In one embodiment, the technical feature that “a number of PDCCH candidate(s) using the first AL configured for a search space for any cell in the first cell set and with an identity value equal to the reference identity value is used to determine the characteristic quantity value” includes the following meaning: search spaces having an identical search space identity that the first scheduling cell is configured with are associated with search space(s) that at least one cell in the first cell set is configured with.

In one embodiment, one or more aggregation levels supported by a search space is/are configured by signaling.

In one embodiment, a number of PDCCH candidates using a same AL comprised by a search space is configured by signaling.

In one embodiment, identity value(s) of at least one search space for any cell in the first cell set is(are) configured by signaling.

In one embodiment, the configuration of search space is cell-specific.

In one embodiment, the configuration of search space is specific to BWPs in cells.

In one embodiment, search space is configured per BWP per cell.

In one embodiment, a search space for any cell in the first cell set is a search space configured for the cell in the first cell set.

In one embodiment, a search space for any cell in the first cell set is a search space specific to a BWP in the cell in the first cell set.

In one embodiment, a search space for any cell in the first cell set is a search space configured in a PDCCH configuration signaling (or IE) for a BWP in the cell in the first cell set.

In one embodiment, a search space for any cell in the first cell set is a search space configured by a configuration signaling (or IE) configuring a BWP in the cell in the first cell set.

In one embodiment, a search space for any cell in the first cell set is a search space configured by a PDCCH configuration signaling (or IE) used for scheduling the cell in the first cell set.

### Embodiment 11

Embodiment 11 illustrates a schematic diagram of a first parameter and a second parameter according to one embodiment of the present application, as shown in FIG. 11. In FIG. 11, each curved-top area in the upper part represents a cell that can be used for downlink, and each curved-top area in the lower part represents a cell that can be used for uplink; cells indicated by curved-top areas having identical fillings can be scheduled by a PDCCH simultaneously; a first parameter is for downlink cells simultaneously scheduled by a PDCCH, while a second parameter is for uplink cells simultaneously scheduled by a PDCCH.

In Embodiment 11, the second information block in the present application is used to indicate a capability parameter set of a transmitter of the second information block, the capability parameter set of the transmitter of the second information block at least comprising a first parameter and a second parameter; the first parameter is used to indicate a number of downlink cells simultaneously scheduled by a PDCCH that are supported by the transmitter of the second information block, while the second parameter is used to indicate a number of uplink cells simultaneously scheduled by a PDCCH that are supported by the transmitter of the second information block.

In one embodiment, a first parameter and a second parameter support independent indications of uplink multi-cell scheduling and downlink multi-cell scheduling, taking into account the asymmetry of uplink and downlink capabilities of the UE, thus enhancing the flexibility of scheduling and reducing the complexity of implementation.

In one embodiment, the second information block is transmitted via an air interface or a wireless interface.

In one embodiment, the second information block comprises all or part of a higher layer signaling or a physical layer signaling.

In one embodiment, the second information block is earlier than the first information block.

In one embodiment, the second information block is later than the first information block.

In one embodiment, the second information block comprises all or part of an RRC signaling, or the second information block comprises all or part of a MAC layer signaling.

In one embodiment, the second information block is transmitted through a PUSCH or a Physical Uplink Control Channel (PUCCH).

In one embodiment, the second information block is used to indicate capabilities of the first node in the present application.

In one embodiment, the technical feature that “the second information block is used to indicate a capability parameter set of a transmitter of the second information block” includes the following meaning: the second information block is used by the first node in the present application to indicate a capability parameter set of the first node.

In one embodiment, the technical feature that “the second information block is used to indicate a capability parameter set of a transmitter of the second information block” includes the following meaning: all or part of the second information block is used for explicitly or implicitly indicating a capability parameter set of a transmitter of the second information block.

In one embodiment, the second information block comprises an IE “Phy-ParametersFRX-Diff”, or the second information block comprises an IE “UE-NR-Capability”.

In one embodiment, the second information block comprises a field “pdcch-MonitoringCA”, or the second information block comprises a field “pdcch-BlindDetectionCA”, or the second information block comprises a field “CA-ParametersNR”, or the second information block comprises a field “searchSpaceSharingCA-DL”, or the second information block comprises a field “searchSpaceSharingCA-UL”, or the second information block comprises a field “SingleDCIMultipleCell-DL”, or the second information block comprises a field “SingleDCIMultipleCel-UL”, or the second information block comprises a field “SingleDCIMultipleCellsearchSpaceSharingCA-DL”, or the second information block comprises a field “SingleDCIMultipleCellsearchSpaceSharingCA-UL”, or the second information block comprises a field “Phy-Parameters”.

In one embodiment, a capability parameter set of a transmitter of the second information block only comprises the first parameter and the second parameter.

In one embodiment, a capability parameter set of a transmitter of the second information block also comprises a parameter other than the first parameter and the second parameter.

In one embodiment, a capability parameter set of a transmitter of the second information block comprises a parameter in an IE “Phy-ParametersFRX-Diff”.

In one embodiment, a capability parameter set of a transmitter of the second information block comprises a parameter in a field “pdcch-MonitoringCA”.

In one embodiment, a capability parameter set of a transmitter of the second information block comprises a parameter in a field “pdcch-BlindDetectionCA”.

In one embodiment, a capability parameter set of a transmitter of the second information block comprises a parameter in a field “CA-ParametersNR”.

In one embodiment, a capability parameter set of a transmitter of the second information block comprises a parameter in a field “Phy-Parameters”.

In one embodiment, the first parameter is different from the second parameter.

In one embodiment, the first parameter and the second parameter are respectively for a downlink and an uplink.

In one embodiment, the first parameter is per band, and the second parameter is per band.

In one embodiment, the first parameter is per CC, and the second parameter is per CC.

In one embodiment, the first parameter is per band combination, and the second parameter is per band combination.

In one embodiment, the first parameter is per feature set, and the second parameter is per feature set.

In one embodiment, the first parameter is a BOOLEAN, or the first parameter is an integer, or the first parameter is a cell list, or the first parameter is an ENUMERATED parameter, or the first parameter is a CHOICE type parameter, or the first parameter is a SEQUENCE type parameter.

In one embodiment, the second parameter is a BOOLEAN, or the second parameter is an integer, or the second parameter is a cell list, or the second parameter is an ENUMERATED parameter, or the second parameter is a CHOICE type parameter, or the second parameter is a SEQUENCE type parameter.

In one embodiment, a transmitter of the second information block is the first node in the present application.

In one embodiment, a number of downlink cell(s) simultaneously scheduled by a PDCCH being supported by the transmitter of the second information block can be equal to or greater than 1.

In one embodiment, a number of uplink cell(s) simultaneously scheduled by a PDCCH being supported by the transmitter of the second information block can be equal to or greater than 1.

In one embodiment, a number of downlink cell(s) simultaneously scheduled by a PDCCH being supported by the transmitter of the second information block is equal to or less than a number of PDSCH(s) simultaneously scheduled by a PDCCH being supported by the transmitter of the second information block.

In one embodiment, a number of downlink cell(s) simultaneously scheduled by a PDCCH being supported by the transmitter of the second information block is no greater than a number of downlink TB(s) simultaneously scheduled by a PDCCH being supported by the transmitter of the second information block.

In one embodiment, a number of uplink cell(s) simultaneously scheduled by a PDCCH being supported by the transmitter of the second information block is equal to or less than a number of PUSCH(s) simultaneously scheduled by a PDCCH being supported by the transmitter of the second information block.

In one embodiment, a number of uplink cell(s) simultaneously scheduled by a PDCCH being supported by the transmitter of the second information block is no greater than a number of uplink TB(s) simultaneously scheduled by a PDCCH being supported by the transmitter of the second information block.

In one embodiment, downlink cells simultaneously scheduled by a PDCCH are cells simultaneously scheduled by a same DL grant or DL assignment.

In one embodiment, downlink cells simultaneously scheduled by a PDCCH are downlink cells that a same PDCCH can schedule at most simultaneously.

In one embodiment, downlink cells simultaneously scheduled by a PDCCH are cells to which all downlink channels or signals simultaneously scheduled by a same PDCCH respectively belong.

In one embodiment, downlink cells simultaneously scheduled by a PDCCH are cells to which all downlink channels or signals simultaneously scheduled by a DCI format carried by a same PDCCH candidate respectively belong.

In one embodiment, downlink cells simultaneously scheduled by a PDCCH are downlink cells simultaneously scheduled by a same DCI format.

In one embodiment, downlink cells simultaneously scheduled by a PDCCH are cells to which all PDSCHs simultaneously scheduled by a same PDCCH respectively belong.

In one embodiment, downlink cells simultaneously scheduled by a PDCCH are cells to which all PDSCHs simultaneously scheduled by a same DCI format respectively belong.

In one embodiment, uplink cells simultaneously scheduled by a PDCCH are cells simultaneously scheduled by a same UL grant or UL assignment.

In one embodiment, uplink cells simultaneously scheduled by a PDCCH are uplink cells that a same PDCCH can schedule at most simultaneously.

In one embodiment, uplink cells simultaneously scheduled by a PDCCH are cells to which all uplink channels or signals simultaneously scheduled by a same PDCCH respectively belong.

In one embodiment, uplink cells simultaneously scheduled by a PDCCH are cells to which all uplink channels or signals simultaneously scheduled by a DCI format carried by a same PDCCH candidate respectively belong.

In one embodiment, uplink cells simultaneously scheduled by a PDCCH are cells to which all uplink channels or signals simultaneously scheduled by a same DCI format respectively belong.

In one embodiment, uplink cells simultaneously scheduled by a PDCCH are cells to which all PUSCHs simultaneously scheduled by a same DCI format respectively belong.

In one embodiment, uplink cells simultaneously scheduled by a PDCCH are cells to which all PUSCHs simultaneously scheduled by a same PDCCH respectively belong.

In one embodiment, the technical feature that “the first parameter is used to indicate a number of downlink cells simultaneously scheduled by a PDCCH that are supported by the transmitter of the second information block” includes the following meaning: the first parameter is used by the first node in the present application to indicate a number of downlink cells simultaneously scheduled by a PDCCH that are supported by the transmitter of the second information block.

In one embodiment, the technical feature that “the first parameter is used to indicate a number of downlink cells simultaneously scheduled by a PDCCH that are supported by the transmitter of the second information block” includes the following meaning: the first parameter is used for explicitly or implicitly indicating a number of downlink cells simultaneously scheduled by a PDCCH that are supported by the transmitter of the second information block.

In one embodiment, the technical feature that “the first parameter is used to indicate a number of downlink cells simultaneously scheduled by a PDCCH that are supported by the transmitter of the second information block” includes the following meaning: the first parameter is used for indicating whether the transmitter of the second information block supports one PDCCH in scheduling multiple downlink cells simultaneously.

In one embodiment, the technical feature that “the first parameter is used to indicate a number of downlink cells simultaneously scheduled by a PDCCH that are supported by the transmitter of the second information block” includes the following meaning: the first parameter is used for indicating a maximum number of downlink cells simultaneously scheduled by a PDCCH that are supported by the transmitter of the second information block.

In one embodiment, the technical feature that “the first parameter is used to indicate a number of downlink cells simultaneously scheduled by a PDCCH that are supported by the transmitter of the second information block” includes the following meaning: the first parameter is used for indicating whether the transmitter of the second information block supports one PDCCH in scheduling multiple downlink cells simultaneously, and, when the transmitter of the second information block supports one PDCCH in scheduling multiple downlink cells simultaneously, indicating a maximum number of downlink cells simultaneously scheduled by one PDCCH being supported by the transmitter of the second information block.

In one embodiment, the technical feature that “the first parameter is used to indicate a number of downlink cells simultaneously scheduled by a PDCCH that are supported by the transmitter of the second information block” includes the following meaning: the first parameter is used for indicating whether the transmitter of the second information block supports one PDCCH in scheduling multiple downlink cells simultaneously; when the first parameter indicates that the transmitter of the second information block supports one PDCCH in scheduling multiple downlink cells simultaneously, a parameter other than the first parameter or the second parameter comprised by a capability parameter set of the transmitter of the second information block is used to indicate a maximum number of downlink cells simultaneously scheduled by one PDCCH being supported by the transmitter of the second information block.

In one embodiment, the technical feature that “the first parameter is used to indicate a number of downlink cells simultaneously scheduled by a PDCCH that are supported by the transmitter of the second information block” includes the following meaning: the first parameter is used for indicating whether the transmitter of the second information block supports one PDCCH in scheduling multiple downlink cells simultaneously; when the first parameter indicates that the transmitter of the second information block supports one PDCCH in scheduling multiple downlink cells simultaneously, a parameter other than the first parameter or the second parameter comprised by a capability parameter set of the transmitter of the second information block is used to indicate a maximum number of carriers of a downlink CA supported by the transmitter of the second information block, where a maximum number of downlink cells simultaneously scheduled by one PDCCH being supported by the transmitter of the second information block is equal to the maximum number of carriers of the downlink CA supported by the transmitter of the second information block.

In one embodiment, the statement that “a number of downlink cell(s) simultaneously scheduled by a PDCCH that is/are supported by the transmitter of the second information block is equal to 1” and the statement that “the transmitter of the second information block only supports one PDCCH only capable of scheduling a single downlink cell” have equivalent meaning or can be replaced by each other.

In one embodiment, the statement that “a number of downlink cells simultaneously scheduled by a PDCCH that are supported by the transmitter of the second information block is greater than 1” and the statement that “the transmitter of the second information block supports one PDCCH in scheduling multiple downlink cell simultaneously” have equivalent meaning or can be replaced by each other.

In one embodiment, when the transmitter of the second information block supports one PDCCH in scheduling multiple downlink cells simultaneously, the transmitter of the second information block no doubt supports one PDCCH in scheduling one downlink cell.

In one embodiment, the technical feature that “the first parameter is used to indicate a number of downlink cells simultaneously scheduled by a PDCCH that are supported by the transmitter of the second information block” includes the following meaning: the first parameter is used for indicating a number of downlink cells simultaneously scheduled by a PDCCH that are supported by the transmitter of the second information block per band.

In one embodiment, the technical feature that “the first parameter is used to indicate a number of downlink cells simultaneously scheduled by a PDCCH that are supported by the transmitter of the second information block” includes the following meaning: the first parameter is used for indicating a number of downlink cells simultaneously scheduled by a PDCCH that are supported by the transmitter of the second information block per band combination.

In one embodiment, the technical feature that “the second parameter is used to indicate a number of uplink cells simultaneously scheduled by a PDCCH that are supported by the transmitter of the second information block” includes the following meaning: the second parameter is used by the first node in the present application to indicate a number of uplink cells simultaneously scheduled by a PDCCH that are supported by the transmitter of the second information block.

In one embodiment, the technical feature that “the second parameter is used to indicate a number of uplink cells simultaneously scheduled by a PDCCH that are supported by the transmitter of the second information block” includes the following meaning: the second parameter is used for explicitly or implicitly indicating a number of uplink cells simultaneously scheduled by a PDCCH that are supported by the transmitter of the second information block.

In one embodiment, the technical feature that “the second parameter is used to indicate a number of uplink cells simultaneously scheduled by a PDCCH that are supported by the transmitter of the second information block” includes the following meaning: the second parameter is used for indicating whether the transmitter of the second information block supports one PDCCH in scheduling multiple uplink cells simultaneously.

In one embodiment, the technical feature that “the second parameter is used to indicate a number of uplink cells simultaneously scheduled by a PDCCH that are supported by the transmitter of the second information block” includes the following meaning: the second parameter is used for indicating a maximum number of uplink cells simultaneously scheduled by a PDCCH that are supported by the transmitter of the second information block.

In one embodiment, the technical feature that “the second parameter is used to indicate a number of uplink cells simultaneously scheduled by a PDCCH that are supported by the transmitter of the second information block” includes the following meaning: the second parameter is used for indicating whether the transmitter of the second information block supports one PDCCH in scheduling multiple uplink cells simultaneously, and, when the transmitter of the second information block supports one PDCCH in scheduling multiple uplink cells simultaneously, indicating a maximum number of uplink cells simultaneously scheduled by one PDCCH being supported by the transmitter of the second information block

In one embodiment, the technical feature that “the second parameter is used to indicate a number of uplink cells simultaneously scheduled by a PDCCH that are supported by the transmitter of the second information block” includes the following meaning: the second parameter is used for indicating whether the transmitter of the second information block supports one PDCCH in scheduling multiple uplink cells simultaneously; when the transmitter of the second information block supports one PDCCH in scheduling multiple uplink cells simultaneously, a parameter other than the first parameter or the second parameter comprised by a capability parameter set of the transmitter of the second information block is used to indicate a maximum number of uplink cells simultaneously scheduled by one PDCCH being supported by the transmitter of the second information block.

In one embodiment, the technical feature that “the second parameter is used to indicate a number of uplink cells simultaneously scheduled by a PDCCH that are supported by the transmitter of the second information block” includes the following meaning: the second parameter is used for indicating whether the transmitter of the second information block supports one PDCCH in scheduling multiple uplink cells simultaneously; when the transmitter of the second information block supports one PDCCH in scheduling multiple uplink cells simultaneously, a parameter other than the first parameter or the second parameter comprised by a capability parameter set of the transmitter of the second information block is used to indicate a maximum number of carriers of an uplink CA supported by the transmitter of the second information block, where a maximum number of uplink cells simultaneously scheduled by one PDCCH being supported by the transmitter of the second information block is equal to the maximum number of carriers of the uplink CA supported by the transmitter of the second information block.

In one embodiment, the statement that “a number of uplink cell(s) simultaneously scheduled by a PDCCH that is/are supported by the transmitter of the second information block is equal to 1” and the statement that “the transmitter of the second information block only supports one PDCCH only capable of scheduling a single uplink cell” have equivalent meaning or can be replaced by each other.

In one embodiment, the statement that “a number of uplink cells simultaneously scheduled by a PDCCH that are supported by the transmitter of the second information block is greater than 1” and the statement that “the transmitter of the second information block supports one PDCCH in scheduling multiple uplink cell simultaneously” have equivalent meaning or can be replaced by each other.

In one embodiment, when the transmitter of the second information block supports one PDCCH in scheduling multiple uplink cells simultaneously, the transmitter of the second information block no doubt supports one PDCCH in scheduling one uplink cell.

In one embodiment, the technical feature that “the second parameter is used to indicate a number of uplink cells simultaneously scheduled by a PDCCH that are supported by the transmitter of the second information block” includes the following meaning: the second parameter is used for indicating a number of uplink cells simultaneously scheduled by a PDCCH that are supported by the transmitter of the second information block per band.

In one embodiment, the technical feature that “the second parameter is used to indicate a number of uplink cells simultaneously scheduled by a PDCCH that are supported by the transmitter of the second information block” includes the following meaning: the second parameter is used for indicating a number of uplink cells simultaneously scheduled by a PDCCH that are supported by the transmitter of the second information block per band combination.

In one embodiment, a number of cells comprised by the first cell set is no greater than a value of the first parameter.

In one embodiment, a number of cells comprised by any cell subset among the H cell subsets in the present application is no greater than a value of the first parameter.

In one embodiment, a total number of cells comprised by all cell subsets among the H cell subsets in the present application is no greater than a value of the first parameter.

### Embodiment 12

Embodiment 12 illustrates a structure block diagram of a processing device in a first node in an example, as shown in FIG. 12. In FIG. 12, a processing device 1200 in a first node is comprised of a first transceiver 1201 and a first receiver 1202. The first transceiver 1201 comprises the transmitter/receiver 456 (comprising the antenna 460), the receiving processor 452, the transmitting processor 455 and the controller/processor 490 in FIG. 4 of the present application; the first receiver 1202 comprises the transmitter/receiver 456 (comprising the antenna 460), the receiving processor 452 and the controller/processor 490 in FIG. 4 of the present application.

In Embodiment 12, the first transceiver 1201 receives a first information block, the first information block used for determining a reference cell, the reference cell belonging to a first cell set, the first cell set comprising multiple cells; and the first receiver 1202 monitors in a first time window at least one PDCCH candidate for DCI format(s) in a target DCI format set, the target DCI format set comprising at least one DCI format for the first cell set; herein, a PDCCH candidate monitored for a DCI format in the target DCI format set is counted for PDCCH candidates monitored for the reference cell; a number of PDCCH candidates monitored for the reference cell in the first time window is no greater than a first threshold, and a number of non-overlapped CCEs for the reference cell in the first time window is no greater than a second threshold, where the first threshold is a positive integer, and the second threshold is a positive integer; a first subcarrier spacing is equal to a subcarrier spacing of at least one subcarrier occupied by the at least one PDCCH candidate monitored in the first time window for DCI format(s) in the target DCI format set in frequency domain, where the first threshold is related to the first subcarrier spacing, and the second threshold is related to the first subcarrier spacing, the first subcarrier spacing being used to determine a time length of one multicarrier symbol comprised by the first time window.

In one embodiment, a target candidate set comprises PDCCH candidate(s) monitored for the reference cell, and a first PDCCH candidate belongs to a search space configured for the reference cell, whether the first PDCCH candidate belongs to the target candidate set is related to whether the search space to which the first PDCCH candidate belongs is configured with at least one DCI format in the target DCI format set.

In one embodiment, the first information block is used to determine a first identity value, the first identity value being a non-negative number; each cell in the first cell set corresponds to one identity value, and the reference cell is a cell in the first cell set corresponding to an identity value equal to the first identity value; a Carrier Indicator Field (CIF) value corresponding to the reference cell is used to determine a CCE occupied by the at least one PDCCH candidate monitored using DCI format(s) in the target DCI format set.

In one embodiment, the first cell set comprises H cell subsets, and any cell subset among the H cell subsets comprises at least one cell, and each cell comprised by any cell subset among the H cell subsets belongs to the first cell set, H being a positive integer greater than 1; size(s) of at least one DCI format in the target DCI format set is(are) related to a number of cells comprised by one cell subset with most cells among the H cell subsets.

In one embodiment, the reference cell is a cell in the first cell set configured with a search space that uses one or more DCI formats only in a reference DCI format set and comprises a smallest total number of PDCCH candidates, where the reference DCI format set is pre-defined or configurable.

In one embodiment, a first scheduling cell is a scheduling cell for the first cell set, and the first scheduling cell is configured with a first search space, a reference identity value being equal to an identity value of the first search space; a characteristic quantity value is equal to a number of PDCCH candidate(s) using a first Aggregation Level (AL) for the first cell set comprised by the first search space, where the first AL is a positive integer; a number of PDCCH candidate(s) using the first AL configured for a search space for any cell in the first cell set and with an identity value equal to the reference identity value is used to determine the characteristic quantity value.

In one embodiment, the first transceiver 1201 transmits a second information block; herein, the second information block is used to indicate a capability parameter set of a transmitter of the second information block, the capability parameter set of the transmitter of the second information block at least comprising a first parameter and a second parameter; the first parameter is used to indicate a number of downlink serving cells simultaneously scheduled by a PDCCH that are supported by the transmitter of the second information block, while the second parameter is used to indicate a number of uplink serving cells simultaneously scheduled by a PDCCH that are supported by the transmitter of the second information block.

### Embodiment 13

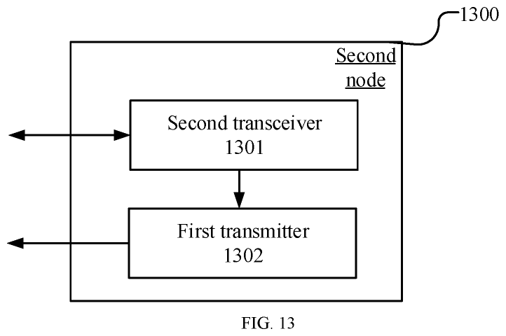

Embodiment 13 illustrates a structure block diagram of a processing device in a second node in an example, as shown in FIG. 13. In FIG. 13, a processing device 1300 in a second node is comprised of a second transceiver 1301 and a first transmitter 1302. The second transceiver 1301 comprises the transmitter/receiver 416 (comprising the antenna 460), the receiving processor 412, the transmitting processor 415 and the controller/processor 440 in FIG. 4 of the present application; the first transmitter 1302 comprises the transmitter/receiver 416 (comprising the antenna 460), the transmitting processor 415 and the controller/processor 440 in FIG. 4 of the present application.

In Embodiment 13, the second transceiver 1301 transmits a first information block, the first information block used for determining a reference cell, the reference cell belonging to a first cell set, the first cell set comprising multiple cells; and the first transmitter 1302 determines in a first time window at least one PDCCH candidate for DCI format(s) in a target DCI format set, the target DCI format set comprising at least one DCI format for the first cell set; herein, a PDCCH candidate monitored for a DCI format in the target DCI format set is counted for PDCCH candidates monitored for the reference cell; a number of PDCCH candidates monitored for the reference cell in the first time window is no greater than a first threshold, and a number of non-overlapped CCEs for the reference cell in the first time window is no greater than a second threshold, where the first threshold is a positive integer, and the second threshold is a positive integer; a first subcarrier spacing is equal to a subcarrier spacing of at least one subcarrier occupied by the at least one PDCCH candidate monitored in the first time window for DCI format(s) in the target DCI format set in frequency domain, where the first threshold is related to the first subcarrier spacing, and the second threshold is related to the first subcarrier spacing, the first subcarrier spacing being used to determine a time length of one multicarrier symbol comprised by the first time window.

In one embodiment, a target candidate set comprises PDCCH candidate(s) monitored for the reference cell, and a first PDCCH candidate belongs to a search space configured for the reference cell, whether the first PDCCH candidate belongs to the target candidate set is related to whether the search space to which the first PDCCH candidate belongs is configured with at least one DCI format in the target DCI format set.

In one embodiment, the first information block is used to determine a first identity value, the first identity value being a non-negative number; each cell in the first cell set corresponds to one identity value, and the reference cell is a cell in the first cell set corresponding to an identity value equal to the first identity value; a Carrier Indicator Field (CIF) value corresponding to the reference cell is used to determine a CCE occupied by the at least one PDCCH candidate monitored using DCI format(s) in the target DCI format set.

In one embodiment, the first cell set comprises H cell subsets, and any cell subset among the H cell subsets comprises at least one cell, and each cell comprised by any cell subset among the H cell subsets belongs to the first cell set, H being a positive integer greater than 1; size(s) of at least one DCI format in the target DCI format set is(are) related to a number of cells comprised by one cell subset with most cells among the H cell subsets.

In one embodiment, the reference cell is a cell in the first cell set configured with a search space that uses one or more DCI formats only in a reference DCI format set and comprises a smallest total number of PDCCH candidates, where the reference DCI format set is pre-defined or configurable.

In one embodiment, a first scheduling cell is a scheduling cell for the first cell set, and the first scheduling cell is configured with a first search space, a reference identity value being equal to an identity value of the first search space; a characteristic quantity value is equal to a number of PDCCH candidate(s) using a first Aggregation Level (AL) for the first cell set comprised by the first search space, where the first AL is a positive integer; a number of PDCCH candidate(s) using the first AL configured for a search space for any cell in the first cell set and with an identity value equal to the reference identity value is used to determine the characteristic quantity value.

In one embodiment, the second transceiver 1301 receives a second information block; herein, the second information block is used to indicate a capability parameter set of a transmitter of the second information block, the capability parameter set of the transmitter of the second information block at least comprising a first parameter and a second parameter; the first parameter is used to indicate a number of downlink serving cells simultaneously scheduled by a PDCCH that are supported by the transmitter of the second information block, while the second parameter is used to indicate a number of uplink serving cells simultaneously scheduled by a PDCCH that are supported by the transmitter of the second information block.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node or the second node, or UE or terminal includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts, etc. The base station or network equipment in the present application includes but is not limited to macro-cellular base stations, micro-cellular base stations, home base stations, relay base station, eNB, gNB, Transmitter Receiver Point (TRP), relay satellite, satellite base station, airborne base station and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first transceiver, receiving a first information block, the first information block used for determining a reference cell, the reference cell belonging to a first cell set, the first cell set comprising multiple cells; and
a first receiver, monitoring in a first time window at least one PDCCH candidate for DCI format(s) in a target DCI format set, the target DCI format set comprising at least one DCI format for the first cell set;
wherein a PDCCH candidate monitored for a DCI format in the target DCI format set is counted for PDCCH candidates monitored for the reference cell; a number of PDCCH candidates monitored for the reference cell in the first time window is no greater than a first threshold, and a number of non-overlapped Control Channel Elements (CCEs) for the reference cell in the first time window is no greater than a second threshold, where the first threshold is a positive integer, and the second threshold is a positive integer; a first subcarrier spacing is equal to a subcarrier spacing of at least one subcarrier occupied by the at least one PDCCH candidate monitored in the first time window for DCI format(s) in the target DCI format set in frequency domain, where the first threshold is related to the first subcarrier spacing, and the second threshold is related to the first subcarrier spacing, the first subcarrier spacing being used to determine a time length of one multicarrier symbol comprised by the first time window.

2. The first node according to claim 1, characterized in that a target candidate set comprises PDCCH candidate(s) monitored for the reference cell, and a first PDCCH candidate belongs to a search space configured for the reference cell, whether the first PDCCH candidate belongs to the target candidate set is related to whether the search space to which the first PDCCH candidate belongs is configured with at least one DCI format in the target DCI format set.

3. The first node according to claim 1, characterized in that the first information block is used for determining a first identity value, the first identity value being a non-negative number; each cell in the first cell set corresponds to one identity value, and the reference cell is a cell in the first cell set corresponding to an identity value equal to the first identity value; a Carrier Indicator Field (CIF) value corresponding to the reference cell is used to determine a CCE occupied by the at least one PDCCH candidate monitored using DCI format(s) in the target DCI format set.

4. The first node according to claim 1, characterized in that the first cell set comprises H cell subsets, and any cell subset among the H cell subsets comprises at least one cell, and each cell comprised by any cell subset among the H cell subsets belongs to the first cell set, H being a positive integer greater than 1; size(s) of at least one DCI format in the target DCI format set is(are) related to a number of cells comprised by one cell subset with most cells among the H cell subsets.

5. The first node according to claim 1, characterized in that the reference cell is a cell in the first cell set configured with a search space that uses one or more DCI formats only in a reference DCI format set and comprises a smallest total number of PDCCH candidates, where the reference DCI format set is pre-defined or configurable.

6. The first node according to claim 1, characterized in that a first scheduling cell is a scheduling cell for the first cell set, and the first scheduling cell is configured with a first search space, a reference identity value being equal to an identity value of the first search space; a characteristic quantity value is equal to a number of PDCCH candidate(s) using a first Aggregation Level (AL) for the first cell set comprised by the first search space, where the first AL is a positive integer; a number of PDCCH candidate(s) using the first AL configured for a search space for any cell in the first cell set and with an identity value equal to the reference identity value is used to determine the characteristic quantity value.

7. The first node according to claim 1, characterized in that the first transceiver transmits a second information block; wherein the second information block is used for indicating a capability parameter set of a transmitter of the second information block, where the capability parameter set of the transmitter of the second information block comprises at least a first parameter and a second parameter; the first parameter is used for indicating a number of downlink serving cell(s) that can be supported by the transmitter of the second information block for being simultaneously scheduled by a PDCCH, while the second parameter is used for indicating a number of uplink serving cell(s) that can be supported by the transmitter of the second information block for being simultaneously scheduled by a PDCCH.

8. A second node for wireless communications, comprising:
a second transceiver, transmitting a first information block, the first information block used for determining a reference cell, the reference cell belonging to a first cell set, the first cell set comprising multiple cells; and
a first transmitter, determining in a first time window at least one PDCCH candidate for DCI format(s) in a target DCI format set, the target DCI format set comprising at least one DCI format for the first cell set;
wherein a PDCCH candidate monitored for a DCI format in the target DCI format set is counted for PDCCH candidates monitored for the reference cell; a number of PDCCH candidates monitored for the reference cell in the first time window is no greater than a first threshold, and a number of non-overlapped CCEs for the reference cell in the first time window is no greater than a second threshold, where the first threshold is a positive integer, and the second threshold is a positive integer; a first subcarrier spacing is equal to a subcarrier spacing of at least one subcarrier occupied by the at least one PDCCH candidate monitored in the first time window for DCI format(s) in the target DCI format set in frequency domain, where the first threshold is related to the first subcarrier spacing, and the second threshold is related to the first subcarrier spacing, the first subcarrier spacing being used to determine a time length of one multicarrier symbol comprised by the first time window.

9. The second node according to claim 8, characterized in that a target candidate set comprises PDCCH candidate(s) monitored for the reference cell, and a first PDCCH candidate belongs to a search space configured for the reference cell, whether the first PDCCH candidate belongs to the target candidate set is related to whether the search space to which the first PDCCH candidate belongs is configured with at least one DCI format in the target DCI format set.

10. The second node according to claim 8, characterized in that the first information block is used for determining a first identity value, the first identity value being a non-negative number; each cell in the first cell set corresponds to one identity value, and the reference cell is a cell in the first cell set corresponding to an identity value equal to the first identity value; a Carrier Indicator Field (CIF) value corresponding to the reference cell is used to determine a CCE occupied by the at least one PDCCH candidate monitored using DCI format(s) in the target DCI format set.

11. The second node according to claim 8, characterized in that the first cell set comprises H cell subsets, and any cell subset among the H cell subsets comprises at least one cell, and each cell comprised by any cell subset among the H cell subsets belongs to the first cell set, H being a positive integer greater than 1; size(s) of at least one DCI format in the target DCI format set is(are) related to a number of cells comprised by one cell subset with most cells among the H cell subsets.

12. The second node according to claim 8, characterized in that a first scheduling cell is a scheduling cell for the first cell set, and the first scheduling cell is configured with a first search space, a reference identity value being equal to an identity value of the first search space; a characteristic quantity value is equal to a number of PDCCH candidate(s) using a first Aggregation Level (AL) for the first cell set comprised by the first search space, where the first AL is a positive integer; a number of PDCCH candidate(s) using the first AL configured for a search space for any cell in the first cell set and with an identity value equal to the reference identity value is used to determine the characteristic quantity value.

13. The second node according to claim 8, characterized in that the second transceiver receives a second information block; wherein the second information block is used for indicating a capability parameter set of a transmitter of the second information block, where the capability parameter set of the transmitter of the second information block comprises at least a first parameter and a second parameter; the first parameter is used for indicating a number of downlink serving cell(s) that can be supported by the transmitter of the second information block for being simultaneously scheduled by a PDCCH, while the second parameter is used for indicating a number of uplink serving cell(s) that can be supported by the transmitter of the second information block for being simultaneously scheduled by a PDCCH.

14. A method in a first node for wireless communications, comprising:
receiving a first information block, the first information block used for determining a reference cell, the reference cell belonging to a first cell set, the first cell set comprising multiple cells; and
monitoring in a first time window at least one PDCCH candidate for DCI format(s) in a target DCI format set, the target DCI format set comprising at least one DCI format for the first cell set;
wherein a PDCCH candidate monitored for DCI format(s) in the target DCI format set is counted for PDCCH candidates monitored for the reference cell; a number of PDCCH candidates monitored for the reference cell in the first time window is no greater than a first threshold, and a number of non-overlapped CCEs for the reference cell in the first time window is no greater than a second threshold, where the first threshold is a positive integer, and the second threshold is a positive integer; a first subcarrier spacing is equal to a subcarrier spacing of at least one subcarrier occupied by the at least one PDCCH candidate monitored in the first time window for DCI format(s) in the target DCI format set in frequency domain, where the first threshold is related to the first subcarrier spacing, and the second threshold is related to the first subcarrier spacing, the first subcarrier spacing being used to determine a time length of one multicarrier symbol comprised by the first time window.

15. The method in the first node according to claim 14, characterized in that a target candidate set comprises PDCCH candidate(s) monitored for the reference cell, and a first PDCCH candidate belongs to a search space configured for the reference cell, whether the first PDCCH candidate belongs to the target candidate set is related to whether the search space to which the first PDCCH candidate belongs is configured with at least one DCI format in the target DCI format set.

16. The method in the first node according to claim 14, characterized in that the first information block is used for determining a first identity value, the first identity value being a non-negative number; each cell in the first cell set corresponds to one identity value, and the reference cell is a cell in the first cell set corresponding to an identity value equal to the first identity value; a Carrier Indicator Field (CIF) value corresponding to the reference cell is used to determine a CCE occupied by the at least one PDCCH candidate monitored using DCI format(s) in the target DCI format set.

17. The method in the first node according to claim 14, characterized in that the first cell set comprises H cell subsets, and any cell subset among the H cell subsets comprises at least one cell, and each cell comprised by any cell subset among the H cell subsets belongs to the first cell set, H being a positive integer greater than 1; size(s) of at least one DCI format in the target DCI format set is(are) related to a number of cells comprised by one cell subset with most cells among the H cell subsets.

18. The method in the first node according to claim 14, characterized in that the reference cell is a cell in the first cell set configured with a search space that uses one or more DCI format only in a reference DCI format set and comprises a smallest total number of PDCCH candidates, where the reference DCI format set is pre-defined or configurable.

19. The method in the first node according to claim 14, characterized in that a first scheduling cell is a scheduling cell for the first cell set, and the first scheduling cell is configured with a first search space, a reference identity value being equal to an identity value of the first search space; a characteristic quantity value is equal to a number of PDCCH candidate(s) using a first Aggregation Level (AL) for the first cell set comprised by the first search space, where the first AL is a positive integer; a number of PDCCH candidate(s) using the first AL configured for a search space for any cell in the first cell set and with an identity value equal to the reference identity value is used to determine the characteristic quantity value.

20. The method in the first node according to claim 14, comprising:
transmitting a second information block;
wherein the second information block is used for indicating a capability parameter set of a transmitter of the second information block, where the capability parameter set of the transmitter of the second information block comprises at least a first parameter and a second parameter; the first parameter is used for indicating a number of downlink serving cell(s) that can be supported by the transmitter of the second information block for being simultaneously scheduled by a PDCCH, while the second parameter is used for indicating a number of uplink serving cell(s) that can be supported by the transmitter of the second information block for being simultaneously scheduled by a PDCCH.
